(19) United States
(12) Patent Application Publication
(10) Pub. No.: US 2025/0365326 A1
(43) Pub. Date: Nov. 27, 2025

(54) INDUSTRIAL MACHINE

(71) Applicant: SUMITOMO HEAVY INDUSTRIES, LTD., Tokyo (JP)

(72) Inventors: Yoshihisa KIYOTA, Yokosuka-shi (JP); Masahito INDOH, Yokosuka-shi (JP); Mizuki KOGAWA, Yokosuka-shi (JP); Yuichi AYATO, Yokosuka-shi (JP); Ikumi SHIOZAKI, Yokosuka-shi (JP)

(21) Appl. No.: 19/295,551

(22) Filed: Aug. 9, 2025

Related U.S. Application Data
(63) Continuation of application No. PCT/JP2024/003209, filed on Feb. 1, 2024.

(30) Foreign Application Priority Data
Feb. 16, 2023 (JP) 2023-022074
Feb. 16, 2023 (JP) 2023-022075

(51) Int. Cl. H04L 65/1089; E02F 9/26; G07C 5/00; G07C 5/08; H04N 7/18

(52) U.S. Cl. CPC H04L 65/1089; E02F 9/26; G07C 5/008; G07C 5/0808; H04N 7/183

(57) ABSTRACT

The present invention relates to an industrial machine executes an information process for participating in an electronic meeting. More specifically, the present invention relates to an industrial machine wherein the information process includes at least one of a process of accepting an invitation for the electronic meeting and a process of holding the electronic meeting.

### CROSS-REFERENCE TO RELATED APPLICATIONS

This is a bypass continuation of International PCT Application No. PCT/JP2024/003209, filed on Feb. 1, 2024, which claims priority to Japanese Patent Application No. 2023-022074, filed on Feb. 16, 2023, and Japanese Patent Application No. 2023-022075, filed on Feb. 16, 2023, which are incorporated by reference herein in their entirety.

### BACKGROUND

### Technical Field

Certain embodiments of the present invention relate to an industrial machine.

### Description of Related Art

The related art discloses a system that transmits an image of a network camera provided in a stacker crane to a participant in an electronic meeting.

### SUMMARY

According to an embodiment of the present invention, there is provided an industrial machine that executes an information process for participating in an electronic meeting.

### BRIEF DESCRIPTION OF THE DRAWINGS

FIG. 1 is a diagram illustrating an industrial machine according to one embodiment of the present invention.

FIG. 2 is a block diagram illustrating a configuration related to an electronic meeting of the industrial machine according to one embodiment.

FIG. 3 is a diagram illustrating a mode in which the industrial machine is participating in the electronic meeting.

FIG. 4A is a diagram illustrating an example of electronic information including an image acquired or generated by an information processing unit.

FIG. 4B is a diagram illustrating an example of electronic information including another image acquired or generated by the information processing unit.

FIG. 4C is a diagram illustrating an example of electronic information including still another image acquired or generated by the information processing unit.

FIG. 5A is a diagram illustrating an example of electronic information including content information generated by the information processing unit.

FIG. 5B is a diagram illustrating an example of electronic information including other content information generated by the information processing unit.

FIG. 6 is a diagram illustrating an example of electronic information including a character string generated by the information processing unit.

FIG. 7 is a diagram illustrating an example of electronic information including a sound acquired or generated by the information processing unit.

FIG. 8 is a flowchart illustrating an electronic meeting process executed by a pre-meeting control unit.

FIG. 9 is a flowchart illustrating another electronic meeting process executed by the meeting control unit.

FIG. 10 is a diagram illustrating an example of a switching process of electronic information based on an operation state of the industrial machine.

FIG. 11 is a diagram illustrating an industrial machine according to another embodiment of the present invention.

FIG. 12 is a block diagram illustrating a configuration of a control system related to a process on electronic information on the industrial machine according to the embodiment.

FIG. 13 is a diagram illustrating an example of a management process of an industrial machine executed by using a communication terminal.

FIG. 14 is a flowchart illustrating a switching process on electronic information executed by an input and output control unit.

FIG. 15 is a diagram illustrating an example in which electronic information which is to be output is switched based on a peripheral situation.

### DETAILED DESCRIPTION

In the related art, various types of management such as state monitoring, safety management, and maintenance management are performed for a construction machine such as an excavator and a crane. However, such management is very complicated.

Such complication is not limited to the construction machine, and occurs in various industrial machines. The industrial machine is a concept including a machine used in various industries such as a work machine such as a construction machine and a transport machine, a machine tool, an agricultural machine, a forming device, an industrial robot, and plant equipment.

It is desirable to provide an industrial machine capable of simplifying various types of management.

Hereinafter, one embodiment of the present invention will be described in detail with reference to the drawings.

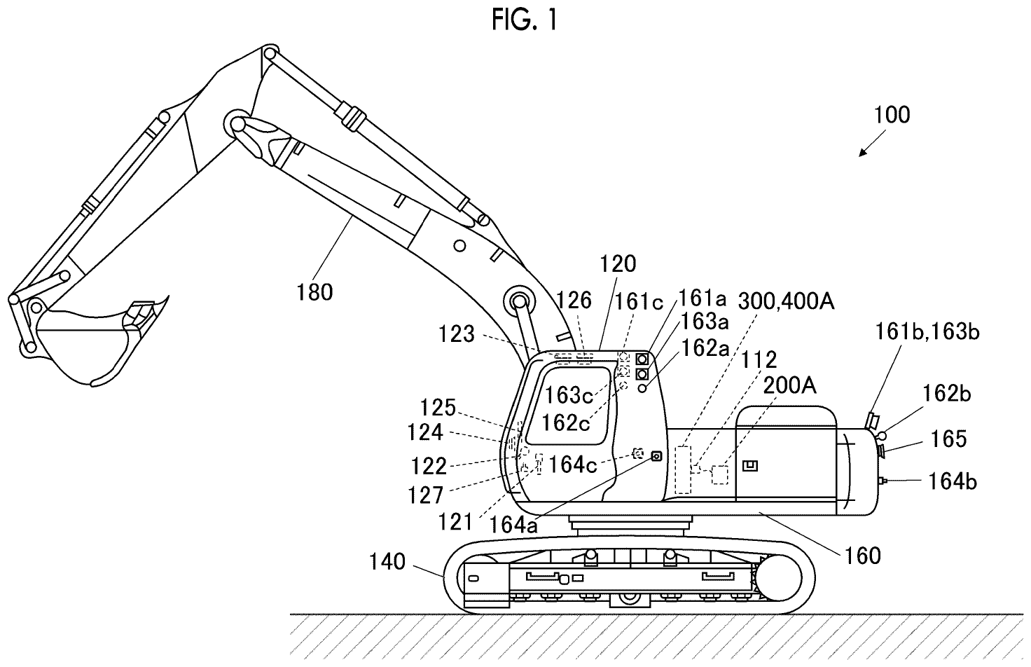

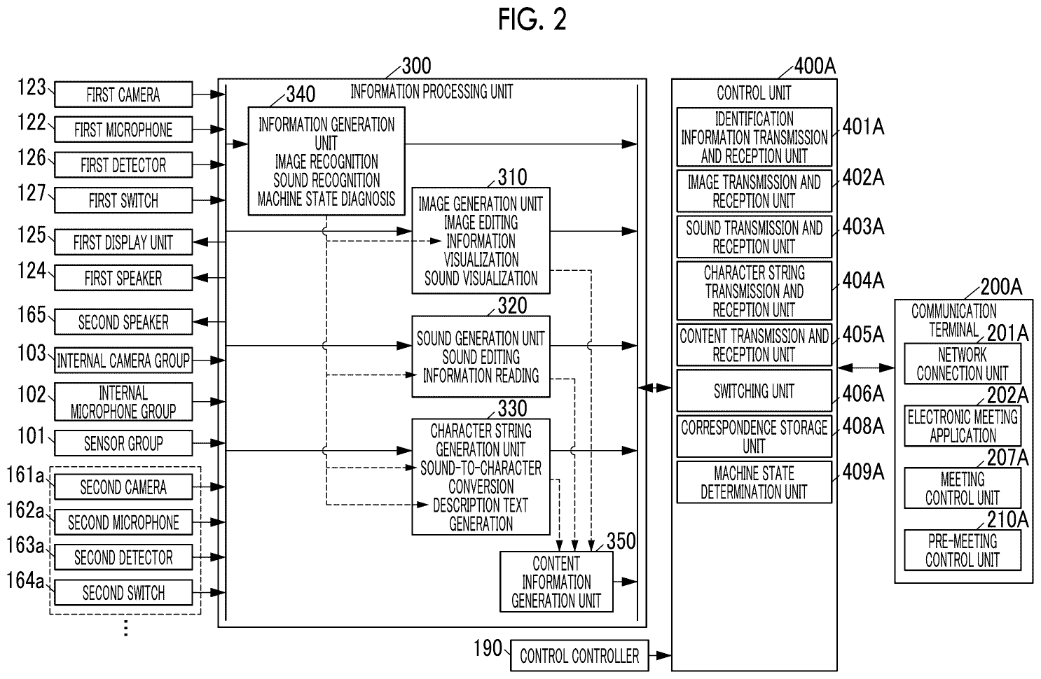

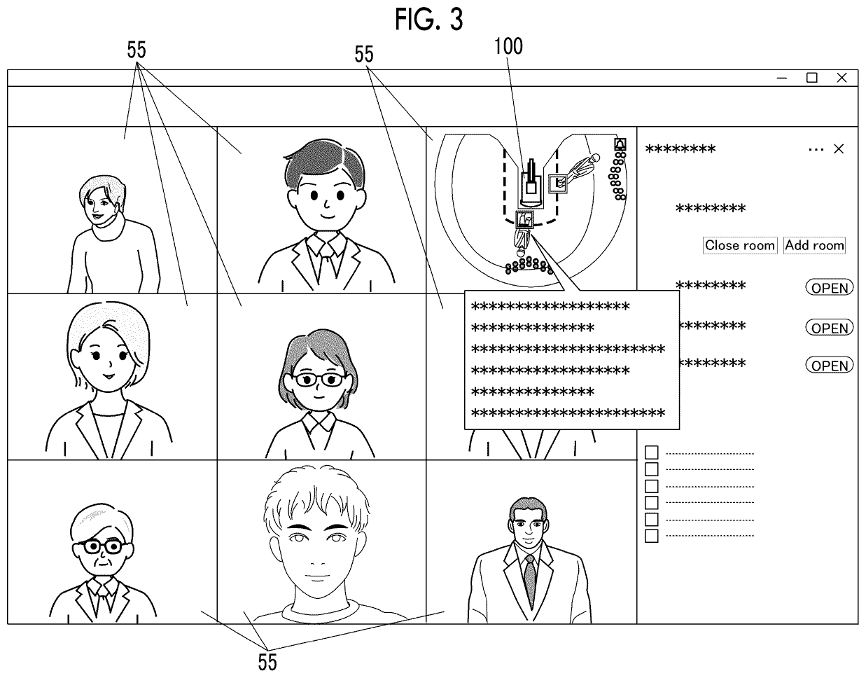

FIG. 1 is a diagram illustrating an industrial machine according to one embodiment of the present invention. FIG. 2 is a block diagram illustrating a configuration related to an electronic meeting of the industrial machine according to one embodiment. FIG. 3 is a diagram illustrating a mode in which the industrial machine is participating in the electronic meeting. FIG. 3 illustrates an image of the electronic meeting displayed on a display unit of each participant.

An industrial machine 100 according to one embodiment is a power excavator, and includes a cab 120, a first drive unit (for example, a lower traveling body) 140, a rotating platform 160 which is rotatable over the first drive unit 140, and a second drive unit (for example, a bucket, an arm portion, a boom portion, and a hydraulic cylinder) 180 supported by the rotating platform 160. The first drive unit 140 is a drive unit that realizes traveling of the industrial machine 100, and has, for example, a configuration of traveling by means of a crawler. The second drive unit 180 is configured to pivotally drive an arm portion and a boom portion by driving a plurality of hydraulic cylinders, and to derrick and move a bucket. The cab 120 is included in the rotating platform 160.

The industrial machine 100 performs an information process of participating in an electronic meeting. As illustrated in FIG. 3, the electronic meeting is a system in which a plurality of participants can exchange information with each other from a remote location. The electronic meeting is a service provided by an external electronic meeting providing system, and the plurality of participants in the electronic meeting are connected to the electronic meeting providing system via a communication network. Then, the plurality of participants can communicate with each other by exchanging an image, a sound, and a character string in the electronic meeting.

In the electronic meeting, a display frame and a sound frame are assigned to each participant, and electronic information including the image and the sound is transmitted to output the electronic information to the display frame and the sound frame of each participant. In addition, in the electronic meeting, a chat function for transmitting the character string to each other can be used. FIG. 3 illustrates an example in which display frames 55 of a plurality of participants are output in a list format and a sound is output from the industrial machine 100 in a state in which sounds of the plurality of participants can be simultaneously output (indicated by a balloon pattern in FIG. 3) in an electronic meeting in which eight participants and one industrial machine 100 participate.

The industrial machine 100, as well as other participants, can transmit electronic information including the image and the sound to the electronic meeting and output the electronic information to the electronic meeting. Further, the industrial machine 100 can switch electronic information to be output to the electronic meeting, based on the image, the sound, and the character string transmitted from the other participants.

### HARDWARE CONFIGURATION OF INDUSTRIAL MACHINE

The cab 120 is provided with an operation unit 121 for operating the first drive unit 140, a rotating unit of the rotating platform 160, and the second drive unit 180. The cab 120 is further provided with a first microphone 122 that acquires a sound in the cab 120, a first camera 123 that acquires a captured image in the cab 120, a first speaker 124 that outputs a sound to the cab 120, and a first display unit 125 that outputs an image to the cab 120. Further, a first detector 126 that detects an object (a driver or the like) in the cab 120 is provided in the cab 120. For example, a three-dimensional scanner or the like using an infrared laser can be applied as the first detector 126.

Further, the rotating platform 160 is provided with a second camera 161a to a fourth camera 161c for acquiring a captured image of the periphery (rearward, leftward, rightward, or the like) and a second microphone 162a to a fourth microphone 162c for acquiring a peripheral sound. Further, a second detector 163a to a fourth detector 163c for detecting a person, an object, or the like located in the periphery (rearward, leftward, rightward, or the like) is provided in the rotating platform 160. For example, a three-dimensional scanner or the like using an infrared laser can be applied as the second detector 163a to the fourth detector 163c.

Further, a first switch 127 for issuing an output request from the cab 120 to the electronic meeting is provided in the cab 120 of the industrial machine 100. On the outside of the industrial machine 100 (for example, rear, left, right, or the like of the rotating platform 160), a second switch 164a to a fourth switch 164c for issuing an output request from the periphery of the industrial machine 100 to the electronic meeting and a second speaker 165 for outputting a sound to the periphery are provided.

Further, the industrial machine 100 is provided with a sensor group 101 (a stress sensor, a vibration sensor, a temperature sensor, and the like) for performing a self-diagnosis, an internal microphone group 102 for detecting an operation sound of the machine, and an internal camera group 103 for acquiring an image inside the machine. The sensor group 101, the internal microphone group 102, and the internal camera group 103 are provided in a machine room driven by a drive source, each unit generating a large stress, and the like.

Further, the industrial machine 100 is provided with an interface unit 112 that is connected to an external communication terminal 200A to be capable of communication. For example, the interface unit 112 is provided in the cab 120 or an accommodation chamber of a control device.

### CONTROL CONFIGURATION

As illustrated in FIG. 2, the industrial machine 100 includes a control controller 190 that controls a machine operation. The control controller 190 receives an operation signal or operation power from the operation unit 121 of the cab 120, and drives the first drive unit 140, the second drive unit 180, or a rotating unit of the rotating platform 160 in response to the operation signal or the operation power. With this drive, the industrial machine 100 is driven in response to an operation of a driver.

The control controller 190 further includes an automatic operation function. When the operator selects the automatic operation, the control controller 190 operates the industrial machine 100 while detecting a person or an obstacle in the periphery, based on an output of the second detector 163a to the fourth detector 163c. In the automatic operation function, the control controller 190 temporarily stops the operation in a case where the person or the obstacle is detected in the periphery, and the operation cannot be continued.

As illustrated in FIG. 2, the industrial machine 100 includes an information processing unit 300 that acquires or generates electronic information to be output to an electronic meeting, and a control unit 400A that performs an information process for participating in the electronic meeting. The information processing unit 300 and the control unit 400A are computers that execute a control program, and each module of the information processing unit 300 and the control unit 400A is software that is realized by the computer executing the control program. The information processing unit 300 and the control unit 400A may be configured to be realized by one computer. The computer may be referred to as a control device. The control controller 190 may also be configured to be integrated with the computer described above, in addition to the information processing unit 300 and the control unit 400A.

The information processing unit 300 includes an image generation unit 310 that generates electronic information on an image, a sound generation unit 320 that generates electronic information on a sound, a character string generation unit 330 that generates electronic information on a character string, an information generation unit 340 that generates detection information on a specific state related to the industrial machine 100, and a content information generation unit 350 that generates content information.

### INFORMATION GENERATION UNIT

The information generation unit 340 performs image recognition, sound recognition, and a machine state diagnosis.

The image recognition is a process of performing image recognition on an image of the first camera 123, the fourth camera 161c, and the internal camera group 103 to generate each piece of information such as the presence or absence of a person and a position thereof, the presence or absence of an obstacle and a position thereof, and the presence or absence of abnormality occurrence.

The sound recognition is a process of performing sound recognition on a sound acquired by the first microphone 122 to the fourth microphone 162c and the internal microphone group 102 to generate information indicating human speech, information on the presence or absence of an abnormality in a machine sound, and the like. The information indicating the human speech may include information on a voice command for the industrial machine 100 and information on a voice command for an electronic meeting.

The machine state diagnosis is a process of diagnosing a state of each unit of the machine based on an output of the sensor group 101, the internal microphone group 102, and the internal camera group 103 to generate self-diagnosis information indicating a result of the diagnosis. The state diagnosis is a diagnosis by a self-diagnosis function. The information generation unit 340 generates a graph indicating a transition of an output value from the output value of the sensor group 101 as a part of the self-diagnosis information. In addition, the information generation unit 340 has a database in which an output of the sensor group 101 and information on the diagnosis result are associated with each other in advance, and generates electronic information including the information on the diagnosis result by collating the self-diagnosis information with the database. The information on the diagnosis result is not limited to being generated based on the database, and may be generated by using a statistical model or a machine learning model.

The information generated by the information generation unit 340 may be transmitted to an electronic meeting system via an image transmission and reception unit 402A, a sound transmission and reception unit 403A, and a character string transmission and reception unit 404A of the control unit 400A. Alternatively, the information generated by the information generation unit 340 may be transmitted to the image generation unit 310, the sound generation unit 320, and the character string generation unit 330 and processed into image information, sound information, and character string information.

### IMAGE GENERATION UNIT

The image generation unit 310 performs image editing, information visualization, and sound visualization to generate electronic information on an image.

The information visualization is a process of converting information generated by the information generation unit 340 into visualization data such as an image. The process includes a process of creating image data of self-diagnosis information, a machine operation state or a control state, and a graph, a table, and a figure included in each work report of the industrial machine 100. More specifically, as a result of the process, a mark image corresponding to a person or an obstacle detected in the periphery of the industrial machine 100, image data in which a magnitude or a frequency of a machine sound acquired by the internal microphone group 102 is represented or graphed, image data in which a detection result of the sensor group 101 is represented or graphed, image data in which self-diagnosis information or a diagnosis result is represented or graphed, image data in which a work history of the industrial machine 100 is represented or converted into a movement trajectory image, and the like are created. For example, the information generation unit 340 accumulates a series of position data obtained from a positioning system (not illustrated), and the image generation unit 310 can generate a movement trajectory image from the position data and map image data.

The sound visualization is a process of converting information obtained by the image recognition and the sound recognition of the information generation unit 340 into a character string image, and a process of creating image data in which a magnitude of an operation sound of the machine acquired by the internal microphone group 102 is represented by a histogram.

The image editing is a process of generating one piece of electronic information by arranging formats of individual images of the first camera 123 to the fourth camera 161c and the internal camera group 103, or creating one piece of electronic information by synthesizing one or both of the visualization data and the sound-visualized data described above with these images. Further, the image editing may include a process of creating one piece of electronic information by synthesizing images of the second camera 161a to the fourth camera 161c. Further, the image generation unit 310 can generate a bird's-eye view image of the industrial machine 100 as one piece of electronic information by synthesizing the images of the second camera 161a to the fourth camera 161c through a process of the image editing.

The information generated by the image generation unit 310 may be transmitted via the image transmission and reception unit 402A of the control unit 400A to be output to a shared screen of the electronic meeting system or to a display frame assigned to each participant. In addition, the information generated by the image generation unit 310 may be transmitted to the content information generation unit 350 and used as image information on content information (to be described below).

### SOUND GENERATION UNIT

The sound generation unit 320 performs sound editing and information reading to generate electronic information on a sound.

The information reading is a process of generating a synthesis sound obtained by converting information generated by the information generation unit 340 by mechanical reading.

The sound editing is a process of generating one piece of electronic information by arranging a format of a sound input from any of the first microphone 122 to the fourth microphone 162c, or generating a synthesis sound generated by information reading as one piece of electronic information. The sound editing may include a process of extracting a target sound such as a human voice and a process of reducing a noise.

The information generated by the sound generation unit 320 may be transmitted as a sound to be output to a sound frame assigned to each participant in the electronic meeting system, via the sound transmission and reception unit 403A of the control unit 400A. In addition, the information generated by the sound generation unit 320 may be transmitted to the content information generation unit 350 and used as sound information on content information (to be described below).

### CHARACTER STRING GENERATION UNIT

The character string generation unit 330 performs sound-to-character conversion and description text generation to generate electronic information on a character string.

The sound-to-character conversion is a process of generating a character string corresponding to a person's speech detected by sound recognition.

The description text generation is a process of creating a description text corresponding to self-diagnosis information or a diagnosis result, a description text corresponding to an operation state or a control state of the industrial machine 100, and a description text corresponding to a work history of the industrial machine 100. The information generation unit 340 has a database in which the self-diagnosis information or the diagnosis result is associated with information on a description text, a database in which the operation state or the control state of the industrial machine 100 is associated with the information on the description text, and a database in which the work history of the industrial machine 100 is associated with the information on the description text in advance, and generates the information on the description text described above by using the database.

The information generated by the character string generation unit 330 may be transmitted as a character string output by a character string exchange function of the electronic meeting system via the character string transmission and reception unit 404A of the control unit 400A. In addition, the information generated by the sound generation unit 320 may be transmitted to the content information generation unit 350 and used as character string information on content information (to be described below).

### CONTENT INFORMATION GENERATION UNIT

The content information generation unit 350 generates content information by receiving information on an image, a sound, and a character string from the image generation unit 310, the sound generation unit 320, and the character string generation unit 330.

The content information corresponds to electronic information obtained by generating one image by superimposing a character string to a combination of a plurality of images and further synchronizing a sound with the image, and making these pieces of information into one piece of information. The content information may be, for example, hierarchical information in which a character string element generated by the character string generation unit 330, an image element generated by the image generation unit 310, and a sound element generated by the sound generation unit 320 are aligned in the same order. The content information includes content information including self-diagnosis information, content information in which an operation state or a control state of the machine is represented, content information in which a work report of the industrial machine 100 is represented, and the like. The work report is a report in which the work history of the industrial machine 100 is summarized in a report format.

The content information generated by the content information generation unit 350 may be transmitted to be output to a shared screen and a shared sound of the electronic meeting system or to a display frame and a sound frame assigned to each participant via a content transmission and reception unit 405A of the control unit 400A.

### CONTROL UNIT

The control unit 400A performs an information process of participating in an electronic meeting. Specifically, the control unit 400A performs a process of accepting an invitation for the electronic meeting, a process of making the invitation for the electronic meeting, a process of transmitting an image and a sound in the electronic meeting, and a process of communicating with other participants in the electronic meeting to switch the image and the sound. The control unit 400A is configured to automatically perform the information process described above, that is, to automatically perform the information process without any operation by an operator, but may be configured to semi-automatically perform the information process described above, that is, to perform the information process with some operations by the operator.

The control unit 400A includes an identification information transmission and reception unit 401A that transmits and receives identification information for specifying the industrial machine 100 as a participant in the electronic meeting. Further, the control unit 400A includes the image transmission and reception unit 402A, the sound transmission and reception unit 403A, the character string transmission and reception unit 404A, and the content transmission and reception unit 405A that respectively transmit and receive electronic information for outputting to the electronic meeting. The image transmission and reception unit 402A transmits and receives electronic information on an image to be displayed in a display frame or a shared screen assigned to each participant in the electronic meeting. The sound transmission and reception unit 403A transmits and receives electronic information on a sound for exchanging a sound to be input and output to and from the sound frame assigned to each participant in the electronic meeting. The character string transmission and reception unit 404A transmits and receives electronic information on a character string for inputting and outputting a character string exchange function for the electronic meeting (for example, a chat function). The content transmission and reception unit 405A transmits and receives electronic information including content information to be displayed on an image frame or a shared screen assigned to each participant in the electronic meeting. The content information means an image including a graph, a figure, and a character string image.

The control unit 400A includes a switching unit 406A that switches, and transmits and receives electronic information acquired or generated by the information processing unit 300 based on various conditions to be described below. The control unit 400A further includes a correspondence storage unit 408A in which a correspondence relationship between a state of the industrial machine 100 (referred to as a “machine state”) and electronic information to be transmitted to the electronic meeting is illustrated, and a machine state determination unit 409A that determines the state of the industrial machine 100.

In addition to the machine state determined by the self-diagnosis of the information generation unit 340, the machine state determination unit 409A determines a peripheral state (presence or absence of a person or an obstacle in the periphery) of the industrial machine 100 and an operation state (forward, backward, arm driving, or the like) of the industrial machine 100 which can be obtained based on information from the control controller 190. The correspondence storage unit 408A illustrates a correspondence relationship between each of the states described above and electronic information corresponding to the state.

The switching unit 406A switches which electronic information among a plurality of pieces of electronic information acquired or generated by the information processing unit 300 is to be transmitted to the electronic meeting by transmitting a command to the image transmission and reception unit 402A, the sound transmission and reception unit 403A, the character string transmission and reception unit 404A, and the content transmission and reception unit 405A.

The control unit 400A can output the image and the sound of the electronic meeting transmitted from the communication terminal 200A to the first display unit 125, the first speaker 124, or the second speaker 165 via the information processing unit 300 or directly.

The communication terminal 200A includes a meeting control unit 207A that switches the electronic information to be output in accordance with a progress of the electronic meeting by controlling the switching unit 406A during the electronic meeting. The meeting control unit 207A determines electronic information to be transmitted to the electronic meeting and controls the switching unit 406A, based on a determination result of the machine state determination unit 409A and input information from other participants in the electronic meeting, via communication between the communication terminal 200A and the control unit 400A.

The communication terminal 200A further includes a pre-meeting control unit 210A that executes an information process for participating in the electronic meeting before the electronic meeting. The pre-meeting control unit 210A is capable of exchanging electronic information with the outside (for example, capable of transmitting and receiving an e-mail) and is capable of managing a schedule, and accepts an invitation for the electronic meeting and makes the invitation for the electronic meeting.

Specifically, in a case where an invitation request for the electronic meeting (for example, an invitation e-mail) from a registered user is received, the pre-meeting control unit 210A checks whether or not the user can participate in the electronic meeting by using the schedule management function, and performs a process of accepting the invitation in a case where the user can participate in the electronic meeting. Then, the pre-meeting control unit 210A performs a process of connecting to the electronic meeting in a case where a date and time of the electronic meeting is reached.

In addition, the pre-meeting control unit 210A performs a process of holding the electronic meeting in a case where a determination result is a specific determination result, based on the determination result of the machine state determination unit 409A, via communication between the communication terminal 200A and the control unit 400A. The specific determination result is an abnormality diagnosis result (a self-diagnosis event) or the like. That is, in a case where the diagnosis result has an abnormality, the pre-meeting control unit 210A performs an information process to request holding of the electronic meeting to an external electronic meeting providing system and an information process to request participation in the electronic meeting to a department associated with the diagnosis result described above (for example, transmitting an e-mail for requesting participation or the like). Then, when an acceptance of the participation request is received from a participant and the date and time of the electronic meeting is reached, the pre-meeting control unit 210A connects to the external electronic meeting providing system to start the electronic meeting. The pre-meeting control unit 210A may also execute a process of holding the electronic meeting based on an automatic operation event or a periphery monitoring event of the industrial machine 100. For example, as the automatic operation event described above, a situation or the like in which an operation is stopped due to an obstacle or the like during the automatic operation can be adopted. As the periphery monitoring event described above, a situation or the like in which an unintended person is detected in the periphery of the industrial machine 100 can be adopted.

The communication terminal 200A may be configured to be always connected to the industrial machine 100, or may be configured to be connectable and disconnectable. The communication terminal 200A is a computer capable of transmitting and receiving data via a communication network such as the Internet. The communication terminal 200A may be a stationary computer or may be a portable computer. The communication terminal 200A is a computer separate from a computer that realizes the information processing unit 300 and the control unit 400A, and is connected to the control unit 400A to be capable of receiving and transmitting data via the interface unit 112. The communication terminal 200A and the computer that realizes the information processing unit 300 and the control unit 400A may be integrated.

The communication terminal 200A further includes a network connection unit 201A and an electronic meeting application 202A. The network connection unit 201A is connected to a communication network such as the Internet via wireless communication, and transmits and receives data. The electronic meeting application 202A communicates with the electronic meeting providing system to realize the reservation, the holding, the invitation, and the acceptance of the invitation for the electronic meeting, and the function of the electronic meeting. The function of the electronic meeting includes a function of transmitting electronic information including an image, a sound, and a character string from a plurality of participants, and a function of displaying and outputting the image, the sound, and the character string received from the plurality of participants and outputting the sound by each participant.

The pre-meeting control unit 210A and the meeting control unit 207A execute the function described above by transmitting a command to the electronic meeting application 202A of the communication terminal 200A.

In addition, one or both of the meeting control unit 207A and the pre-meeting control unit 210A of the communication terminal 200A may be provided in the control unit 400A.

### SPECIFIC EXAMPLE OF ELECTRONIC INFORMATION

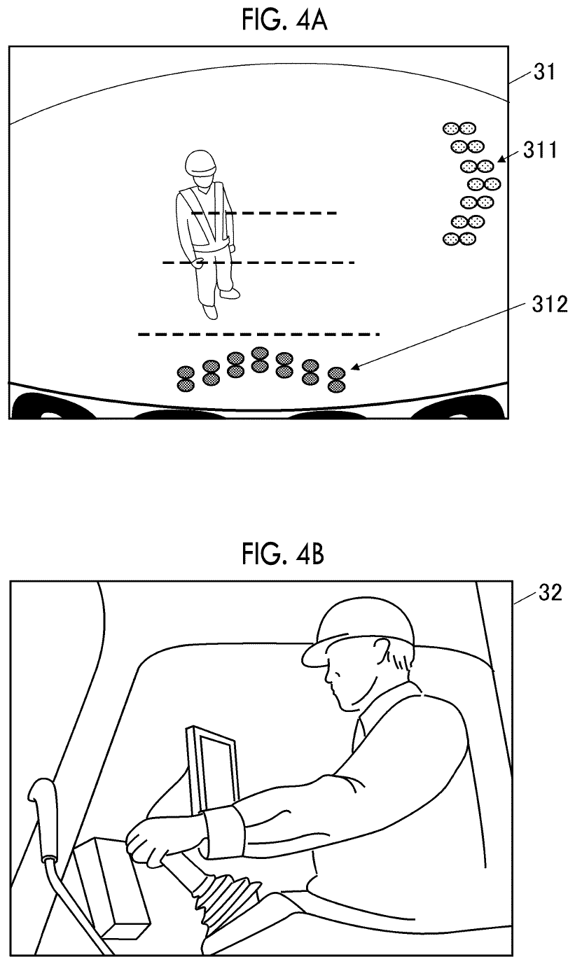

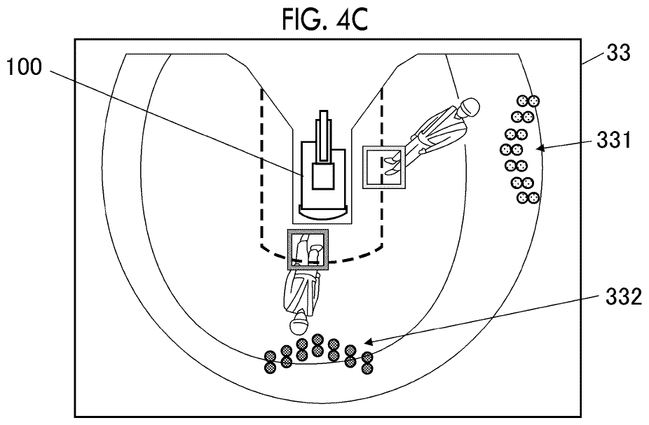

Subsequently, a specific example of electronic information to be transmitted to an electronic meeting by the industrial machine 100 will be described. FIGS. 4A to 4C illustrate examples of electronic information including an image acquired or generated by the image generation unit 310 of the information processing unit 300, FIG. 4A illustrates an image example of a back monitor, FIG. 4B illustrates an image example inside a cab, and FIG. 4C illustrates an image example of the industrial machine 100 in a bird's-eye view. As illustrated in FIG. 4A, the electronic information on the image acquired or generated by the image generation unit 310 of the information processing unit 300 includes an image 31 of the back monitor acquired from a third camera 161b. The image 31 may include image elements 311 and 312 in which a person or an obstacle detected by the third detector 163b is illustrated. In addition, as illustrated in FIG. 4B, one piece of the electronic information on the image described above includes an image 32 in the cab 120. The image in the cab 120 may be an image captured from above or in front of the cab. Further, as illustrated in FIG. 4C, one piece of the electronic information on the image described above includes a bird's-eye view image 33 illustrating the industrial machine 100 and the periphery thereof, which is generated by synthesizing images of the second camera 161a to the fourth camera 161c. The bird's-eye view image 33 may include image elements 331 and 332 in which a person or an obstacle detected by the second detector 163a to the fourth detector 163c is illustrated.

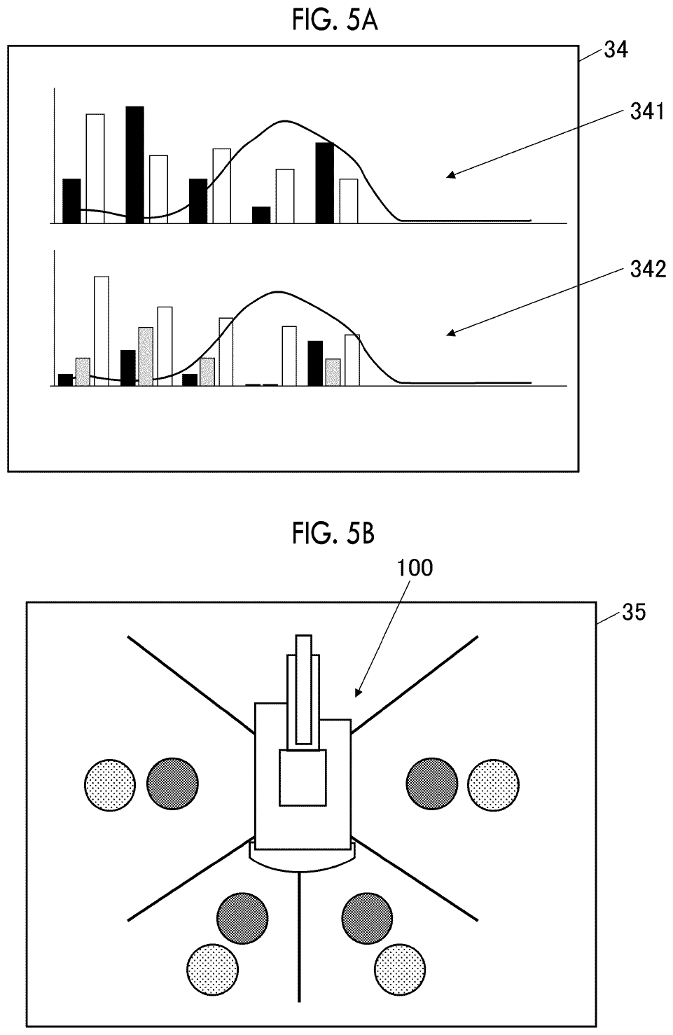

FIGS. 5A and 5B illustrate an example of electronic information including content information generated by the content information generation unit 350 of the information processing unit 300, FIG. 5A is an image example of a state diagnosis report, and FIG. 5B is an example of a report image of a peripheral state or a peripheral control state of the industrial machine 100. A report 34 of a state diagnosis in FIG. 5A includes statistical graphs 341 and 342 of outputs of the sensor group 101 or the internal microphone group 102. The report 34 of the state diagnosis may include a character string image representing a diagnosis type or a diagnosis result. A peripheral situation of the industrial machine 100 (the number of persons or obstacles in the vicinity, the number of persons or obstacles located slightly away), a range in which the industrial machine 100 detects a person or an obstacle (left, right, left rear, right rear, and the like), or the like is illustrated in a report 35 in FIG. 5B.

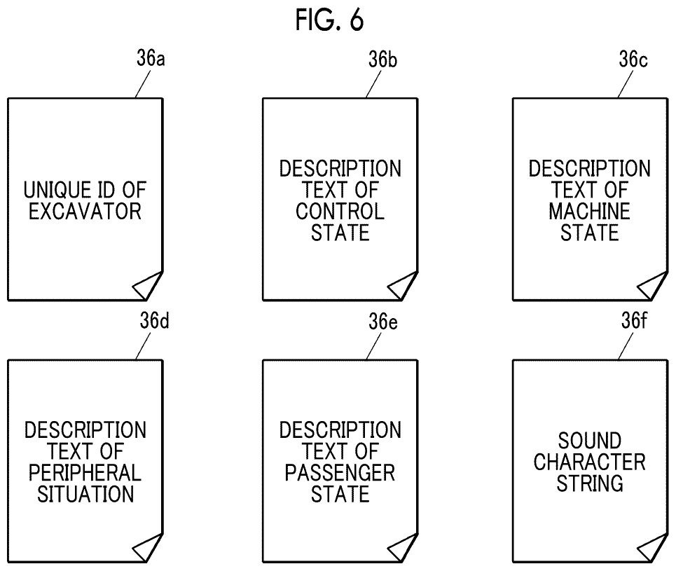

FIG. 6 is a diagram illustrating an example of electronic information on a character string generated by the character string generation unit 330 of the information processing unit 300. The electronic information on the character string is information that can be converted into a character string image by the image generation unit 310, and is information that can be converted into a synthesis sound by the sound generation unit 320. The character string generated by the information processing unit 300 includes a character string 36a of a unique ID (identification information) of the industrial machine 100. In addition, a character string generated by the character string generation unit 330 includes a description text (during an operation, during rest, during forward movement, during rearward movement, during rotating, during arm derricking, and the like) 36b of a control state of the industrial machine 100, a description text (degree of normality of each unit based on an output of the sensor group 101, the internal microphone group 102, and the internal camera group 103) 36c of a machine state (a self-diagnosis) of the industrial machine 100, a description text (a detection result of a person or an obstacle in the periphery, a road surface condition in the periphery, and the like) 36d of a peripheral situation (a result of periphery monitoring), and a description text (presence or absence of a passenger, estimated activity level of the passenger obtained by the information generation unit 340 recognizing an image of the first camera 123, whether or not a driving operation is performed in accordance with a regulation, and the like) 36e of a state of a passenger such as a driver. Further, the character string generated by the information processing unit 300 includes a sound character string 36f obtained by converting speech of a driver or a worker in the periphery.

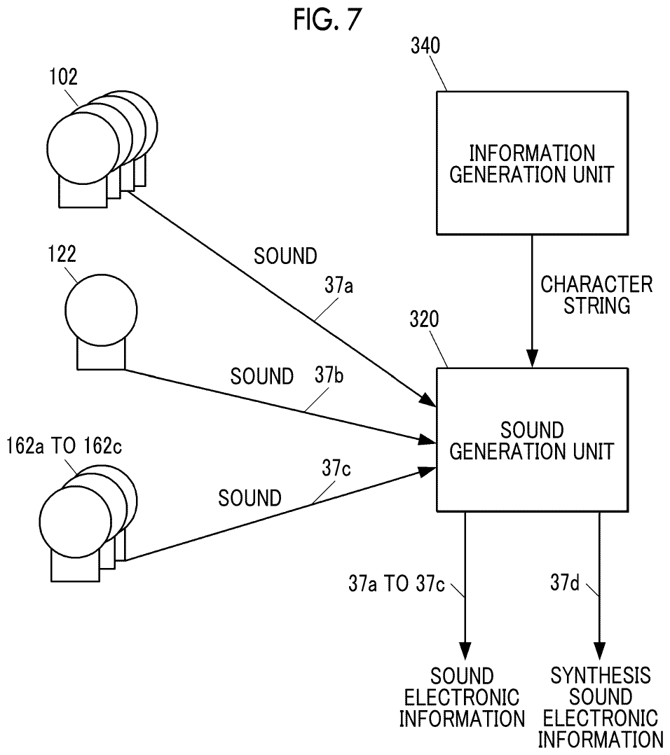

FIG. 7 is a diagram illustrating an example of electronic information on a sound acquired or generated by the sound generation unit 320 of the information processing unit 300. The sound generation unit 320 can acquire sound data input from the internal microphone group 102, the first microphone 122, and each of the second microphone 162a to the fourth microphone 162c, as sound electronic information 37a to 37c. Further, the sound generation unit 320 can generate sound data in which information recognized by the information generation unit 340 is mechanically read as synthesis sound electronic information 37d.

The information processing unit 300 may be configured to have a plurality of types of software mixed and to generate a plurality of types of electronic information on images, sounds, or character strings by the plurality of types of software. The plurality of types of software may be software developed by different manufacturers, or may be software having different development platforms. The control unit 400A can uniformly handle the electronic information generated from such a plurality of types of software, and select any one of the electronic information to transmit to an electronic meeting. That is, the control unit 400A plays a role of supervising the different types of software for generating the electronic information.

### ELECTRONIC MEETING PROCESS

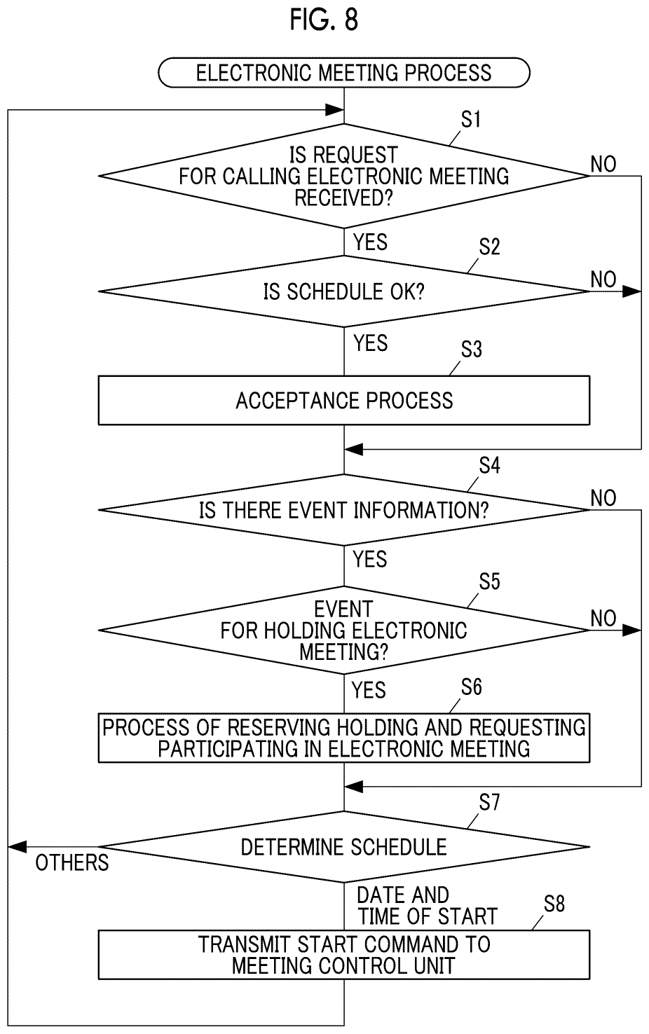

FIG. 8 is a flowchart illustrating an electronic meeting process executed by a pre-meeting control unit. The electronic meeting process in FIG. 8 is always executed during activation of the pre-meeting control unit 210A.

The pre-meeting control unit 210A periodically determines whether or not an invitation request for an electronic meeting is received (step S1), performs a schedule check (checks whether or not a time of the schedule overlaps with another electronic meeting or a process that cannot overlap with the other electronic meeting) when the request is received (step S2), and accepts the invitation when there is no overlap in the schedule (step S3). That is, in step S3, the pre-meeting control unit 210A replies to the acceptance (for example, an acceptance e-mail), and sets the schedule such that a command is to be invoked at a date and time of the electronic meeting.

In addition, the pre-meeting control unit 210A receives event information on the industrial machine 100 (step S4). When the event information satisfies a condition for holding the electronic meeting (step S5), the pre-meeting control unit 210A performs a process of reserving the holding of the electronic meeting and a process of requesting a department corresponding to a diagnosis result to participate in the electronic meeting (step S6). In step S6, the pre-meeting control unit 210A sets the schedule such that a command is to be invoked at a date and time of the electronic meeting.

The event information input by the pre-meeting control unit 210A in step S4 includes an operation event, an automatic operation event, a periphery monitoring event, an operation event for the electronic meeting, and a diagnosis event of the industrial machine 100.

The operation event corresponds to a start, a middle, or an end of a predetermined operation (forward, rearward, rotating, arm driving, or the like) in the industrial machine 100. The automatic operation event is an event that occurs in the automatic operation, and includes, for example, that the automatic operation is started, that the automatic operation is in a stopped state as a result of the periphery monitoring, and the like. The periphery monitoring event corresponds to an event regarding a monitoring result in the periphery of the industrial machine 100, and includes, for example, a case where a person or an obstacle is detected in front of, behind, to the left of, or to the right of the industrial machine 100. The operation event indicates that an operation unit for the electronic meeting is operated by a worker, and corresponds to the fact that the first switch 127 and the second switch 164a to the fourth switch 164c, or an operation switch for holding the electronic meeting (not illustrated) is operated. The diagnosis event is an event in a self-diagnosis function of the industrial machine 100, and includes generation of a diagnosis result of an abnormality or a warning, generation of a diagnosis error in which a normal diagnosis is difficult, and the like.

The event information that is determined as the electronic meeting holding in step S5 is set in advance as the event information to be discussed or checked in the electronic meeting among a plurality of pieces of event information described above. In the setting, the pre-meeting control unit 210A may be configured to appropriately adjust a reservation date and time of the electronic meeting according to an importance and urgency of the event information. Further, the pre-meeting control unit 210A may immediately request the holding of the electronic meeting in a case where there is event information having high urgency.

Subsequently, the pre-meeting control unit 210A performs the schedule determination (step S7), and transmits a start command of the electronic meeting to the meeting control unit 207A when a participation date and time of the electronic meeting is reached (step S8). Then, the pre-meeting control unit 210A returns the process to step S1 again.

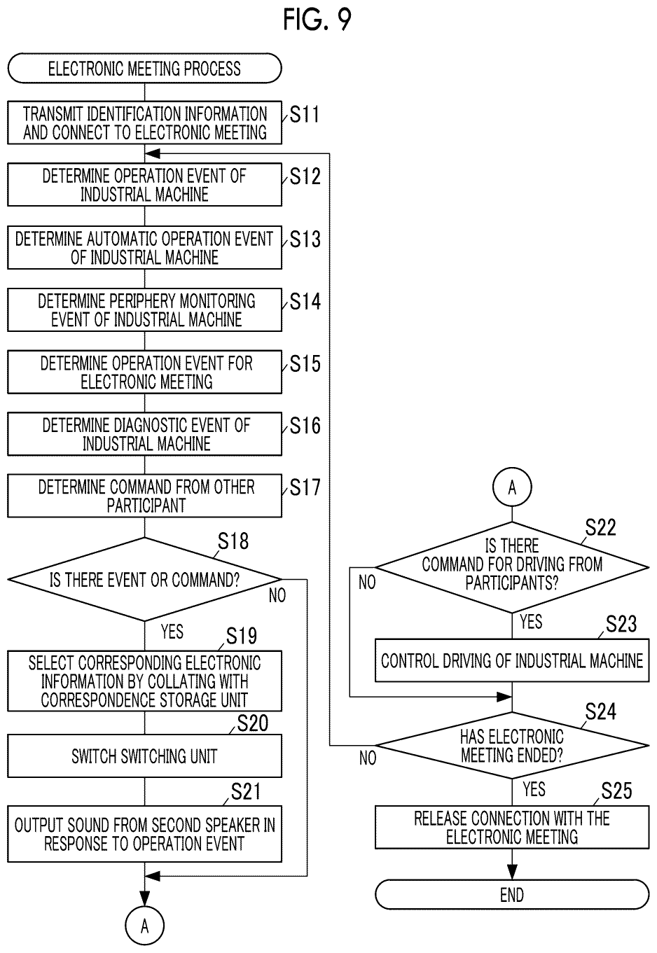

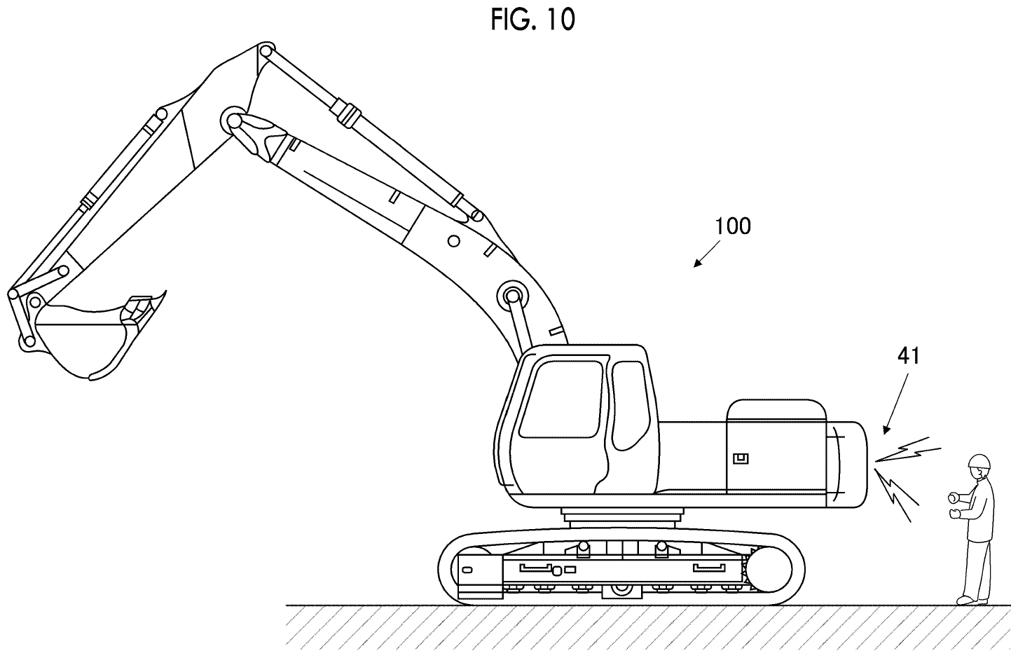

FIG. 9 is a flowchart illustrating an electronic meeting process executed by a meeting control unit. The electronic meeting process in FIG. 9 is started based on a start command from the pre-meeting control unit 210A.

When the start command for an electronic meeting is received from the pre-meeting control unit 210A, the meeting control unit 207A transmits identification information indicating the industrial machine 100 to an electronic meeting providing system via the identification information transmission and reception unit 401A, and connects to the electronic meeting (step S11).

Thereafter, the meeting control unit 207A proceeds to a loop process (steps S12 to S24) including a process (steps S12 to S20) of switching electronic information on an image, a sound, and a character string to be output to the electronic meeting according to a condition.

When the process proceeds to the loop process, first, the meeting control unit 207A determines whether or not an occurrence notification of an operation event of the industrial machine 100 is received (step S12). The operation event includes a start of a predetermined operation (forward, rearward, rotating, arm driving, or the like) of the industrial machine 100. Further, the meeting control unit 207A determines whether or not an occurrence notification of an automatic operation event is received in a case where an automatic operation of the industrial machine 100 is selected (step S13). The automatic operation event includes that the automatic operation is started, that the automatic operation is stopped depending on a result of periphery monitoring, and the like.

Further, the meeting control unit 207A determines whether or not an occurrence notification of a periphery monitoring event of the industrial machine 100 is received (step S14). The periphery monitoring event includes detection of a person or an obstacle in front, rear, left, and right of the industrial machine 100.

Further, the meeting control unit 207A determines whether or not an occurrence notification of an operation event for the electronic meeting is received from a worker (step S15). The operation event includes that any one of the first switch 127 and the second switch 164a to the fourth switch 164c is operated.

Further, the meeting control unit 207A determines whether or not an occurrence notification of a diagnosis event of the industrial machine 100 is received (step S16). The diagnosis event includes a determination of an abnormality or a warning in a self-diagnosis function of the industrial machine 100. The notification in steps S12 to S16 is transmitted from the machine state determination unit 409A to the meeting control unit 207A.

Further, the meeting control unit 207A determines whether or not a command is transmitted from another participant in the electronic meeting (step S17). The determination in step S17 is realized by the meeting control unit 207A performing image recognition, sound recognition, or character string collation from the image, the sound, and the character string transmitted from the other participant in the electronic meeting to determine whether or not the predetermined command is included.

Then, when there is an occurrence notification of the event or a predetermined command in steps S12 to S17 (YES in step S18), the meeting control unit 207A acquires information indicating which electronic information corresponds to the event or the command described above by collating with a database of the correspondence storage unit 408A (step S19). Then, the meeting control unit 207A switches the switching unit 406A from among a plurality of types of electronic information transmitted from the information processing unit 300 such that electronic information indicated by the information acquired in step S19 is transmitted to the electronic meeting (step S20).

By the process in step S20, the electronic information selected according to a condition among various images, synthesis images, various types of content information, various sounds, and various character strings is transmitted to the electronic meeting and output to other participants.

Further, in the loop process, when any one of the second switch 164a to the fourth switch 164c is operated and the operation event occurs, the meeting control unit 207A performs a process of outputting the sound transmitted from the other participant from the second speaker 165 near the operated switch (step S21). In step S21, in a case where a chat function is used in the electronic meeting or in a case where the character string image is included in a shared screen, the meeting control unit 207A may execute a process of converting the output information into a character string, and converting it into a sound and outputting the sound as a synthesis sound.

Further, in the loop process, the meeting control unit 207A determines whether or not a command for driving the industrial machine 100 is transmitted from other participants in the electronic meeting (step S22), and controls the operation of the industrial machine 100 (step S23) in a case where the command for driving is transmitted. The command for driving is recognized by the meeting control unit 207A performing image recognition, sound recognition, or character string collation from the image, the sound, and the character string transmitted from other participants in the electronic meeting. The control of the operation in step S23 may be set to control only a few limited operations, such as stop and operation permission, for example.

Then, the meeting control unit 207A determines whether or not the electronic meeting has ended (step S24), and returns the process to step S12 when it has not ended. Then, when the electronic meeting has ended, the meeting control unit 207A releases the connection with the electronic meeting (step S25), and ends the electronic meeting process.

### EXAMPLE OF SWITCHING ELECTRONIC INFORMATION

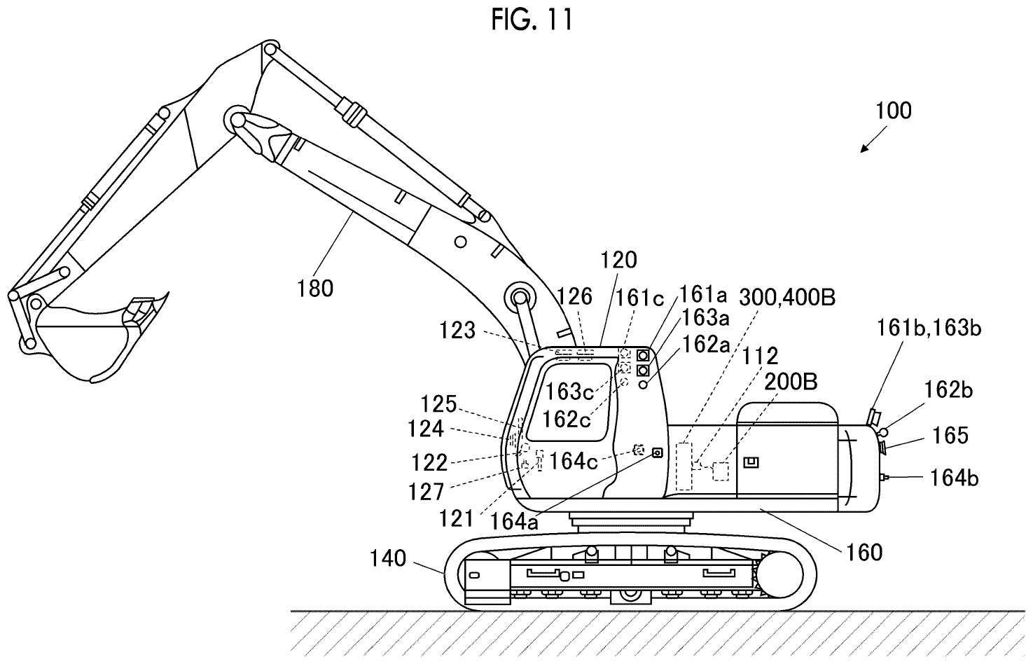

Here, a specific example of a switching process of electronic information in steps S12 to S20 will be described. FIG. 10 is a diagram illustrating an example of the switching process of the electronic information based on an operation state of an industrial machine. For example, in a case where a person or an obstacle approaches a rear portion of the industrial machine 100 and the third detector 163b detects the person or the obstacle and outputs a warning sound 41, the meeting control unit 207A determines that a periphery monitoring event occurs. Then, the meeting control unit 207A switches an output to electronic information on a back monitor in FIG. 4A, based on the occurrence of the periphery monitoring event.

In addition, in a case where an operation event occurs in which any of the first switch 127 and the second switch 164a to the fourth switch 164c is operated by a worker, the meeting control unit 207A switches the output to electronic information including an image and a sound of a camera and a microphone installed in the periphery of the switch.

In addition, in a case where a diagnosis event of determining an abnormality occurs in the self-diagnosis function of the industrial machine 100 of the information generation unit 340, the meeting control unit 207A switches the output to electronic information including an image of an abnormality diagnosis location and an image of a diagnosis report of a state diagnosis at the diagnosis location.

In addition, when a participant of the electronic meeting speaks a predetermined command such as “switch to display of a side monitor”, the meeting control unit 207A switches the output to electronic information including an image on the side monitor.

In addition, in a case where conditions for requesting the switching of a plurality of pieces of electronic information overlap with each other, the meeting control unit 207A may calculate a priority level of each request and preferentially switch to electronic information having a high priority level, or may divide a screen of the image into a plurality of screens and output the electronic information on the plurality of images in the electronic meeting at the same time.

### MONITOR OF ELECTRONIC MEETING

An image and a sound of an electronic meeting are also transmitted to the control unit 400A of the industrial machine 100, which is a participant in the electronic meeting. The control unit 400A normally outputs the image and the sound from the first display unit 125 and the first speaker 124 in the cab 120. Further, in a case where any of the second switch 164a to the fourth switch 164c is operated and there is an operation command, the control unit 400A outputs the sound of the electronic meeting from the second speaker 165 that outputs the sound to the periphery of the industrial machine 100. Further, the control unit 400A may control the output of the image and the sound to a tablet terminal (a terminal possessed by a manager) provided away from the industrial machine 100 or switching of an output destination based on a machine state or a command from another participant. In addition, in a case where there is no operator in the periphery of the industrial machine 100, a configuration may be adopted in which the image and the sound of the electronic meeting transmitted to the industrial machine 100 are not output.

As described above, with the industrial machine 100 of one embodiment, the industrial machine 100 executes the information process of participating in the electronic meeting. Therefore, the manager and the industrial machine 100 participate in the electronic meeting, so that the manager can exchange information with the industrial machine 100 via the electronic meeting. Then, by using the exchange of the information, it is possible to simplify various types of management such as state monitoring, safety management, and maintenance management of the industrial machine 100 via the electronic meeting.

Specifically, the information process described above performed by the industrial machine 100 includes a process of accepting the invitation for the electronic meeting and a process of holding the electronic meeting. Therefore, it is possible to simplify the management work of the industrial machine 100, which includes the processes up to participating in the electronic meeting. Further, since the industrial machine 100 itself holds the electronic meeting, the electronic meeting can be held with any state generated in the industrial machine 100 as a condition. In addition, in one embodiment, the industrial machine 100 is configured to perform both the process of accepting the invitation for the electronic meeting and the process of holding the electronic meeting, but may be configured to perform only one of the processes. Even when only one of the processes is performed, it is possible to simplify the management work including the processes up to participating in the electronic meeting.

Further, the information process described above performed by the industrial machine 100 includes a process of transmitting the identification information on the industrial machine 100 to identify the participant of the electronic meeting to the electronic meeting. With this configuration, the participant of the electronic meeting is the industrial machine 100 itself, and it is easy for the participant to recognize that the operator or the manager of the industrial machine 100 does not participate in the electronic meeting.

Further, the information process described above performed by the industrial machine 100 includes a process of acquiring or generating a plurality of pieces of electronic information to be output to the electronic meeting, and the electronic information includes an image, a sound, content information, and a character string. Through the information process, the participant of the electronic meeting can visually and auditorily check a state of the industrial machine 100, and can perform various types of management such as state monitoring, safety management, and maintenance management of the industrial machine 100.

More specifically, the plurality of pieces of electronic information described above include, for example, a captured image inside or in the periphery of the industrial machine 100, a bird's-eye view image of the industrial machine 100 in which a plurality of captured images in the periphery are synthesized, a captured image of the cab 120, content information including self-diagnosis information on the industrial machine 100, content information in which an operation state or a control state of the industrial machine 100 is represented, content information in which a work report of the industrial machine 100 is represented, a peripheral sound of the industrial machine 100, a sound of the cab 120, an operation sound of each unit of the industrial machine 100, a character string obtained by converting speech of a driver, a character string obtained by converting speech of a worker in the periphery, a character string generated by a self-diagnosis function, a character string generated by a periphery monitoring function, a synthesis sound obtained by converting the character string into a sound, and the like. With such electronic information, the participant of the electronic meeting can more accurately identify the situation of the industrial machine 100 and the periphery thereof.

In addition, in one embodiment, the industrial machine 100 has the configuration for acquiring or generating all the electronic information described above, but may have a configuration for acquiring or generating only the electronic information on the image or only the electronic information on the sound. In addition, two or more of the plurality of types of electronic information described above may be acquired or generated. Since there are more types of electronic information, it is possible to more efficiently perform various types of management by effectively utilizing the electronic information. However, even with a small number of types of electronic information, the electronic information can be used for various types of management of the industrial machine 100.

Further, according to the industrial machine 100 of one embodiment, the electronic information to be output to the electronic meeting is switched from the plurality of pieces of electronic information described above according to the condition. With this configuration, even when a large number of pieces of electronic information which can be output exist, the electronic information according to the situation can be output in the electronic meeting.

Specifically, as the condition described above, a request from another participant, a self-diagnosis event of the industrial machine 100, an operation event of the industrial machine 100, an automatic operation event of the industrial machine 100, a periphery monitoring event of the industrial machine 100, and an operation event for an electronic meeting in the industrial machine 100 are included. By switching the electronic information according to such event information, the output content of the electronic information from the industrial machine 100 in the electronic meeting can be made more appropriate.

Further, according to the industrial machine 100 of one embodiment, the sound of the electronic meeting and the synthesis sound obtained by converting the character string in the image of the electronic meeting into a sound are output from the speaker of the industrial machine 100, for example, in a case where the second switch 164a to the fourth switch 164c are operated or the like. With this configuration, the worker can identify the content of the electronic meeting or participate in the electronic meeting from the periphery of the industrial machine 100.

Further, according to the industrial machine 100 of one embodiment, an invitation for the electronic meeting is made based on the self-diagnosis event of the industrial machine 100, the automatic operation event of the industrial machine 100, or the periphery monitoring event of the industrial machine 100. Therefore, the electronic meeting can be automatically held according to the state of the industrial machine 100 and the peripheral situation of the industrial machine 100.

One embodiment of the present invention has been described above. However, the present invention is not limited to one embodiment described above. For example, in one embodiment, the example in which the industrial machine 100 is a power excavator is described. However, the industrial machine 100 may be a machine used in various industries, such as a work machine such as a construction machine and a transport machine, a machine tool, an agricultural machine, a forming device, an industrial robot, and plant equipment. In addition, details illustrated in one embodiment can be appropriately changed without departing from the gist of the invention.

### ANOTHER EMBODIMENT

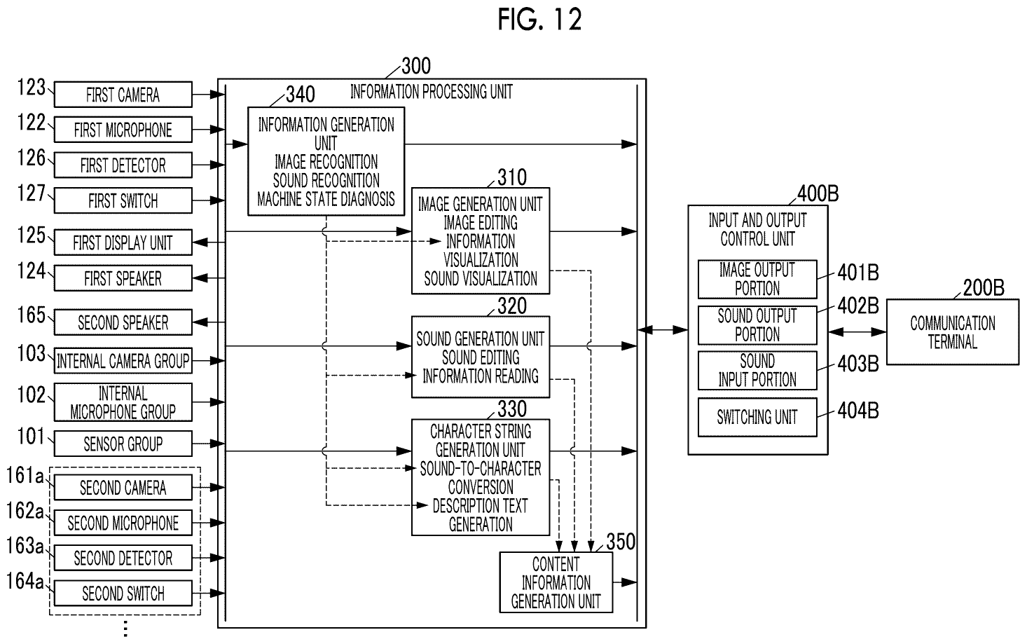

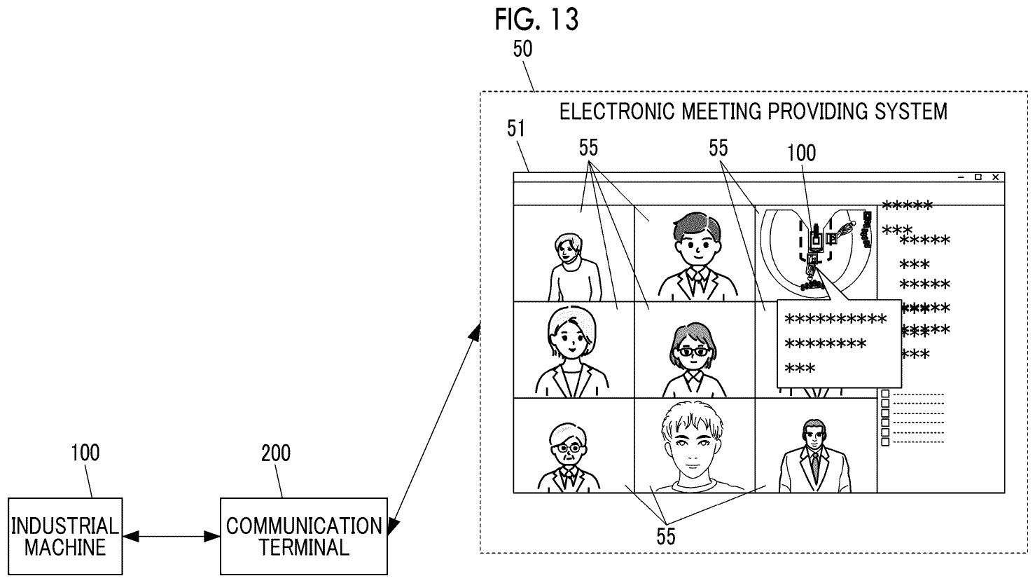

FIG. 11 is a diagram illustrating an industrial machine according to another embodiment of the present invention. FIG. 12 is a block diagram illustrating a configuration of a control system related to a process of electronic information on the industrial machine according to another embodiment. FIG. 13 is a diagram illustrating an example of a management process of the industrial machine executed by using a communication terminal.

The industrial machine 100 according to another embodiment is a power excavator, and includes a cab 120, a first drive unit (for example, a lower traveling body) 140, a rotating platform 160 which is rotatable over the first drive unit 140, and a second drive unit (for example, a bucket, an arm portion, a boom portion, and a hydraulic cylinder) 180 supported by the rotating platform 160. The first drive unit 140 is a drive unit that realizes traveling of the industrial machine 100, and has, for example, a configuration of traveling by means of a crawler. The second drive unit 180 is configured to pivotally drive an arm portion and a boom portion by driving a plurality of hydraulic cylinders, and to derrick and move a bucket. The cab 120 is included in the rotating platform 160.

The industrial machine 100 is configured to acquire or generate electronic information including an image and a sound, and to be connectable to a communication terminal 200B via the interface unit 112. The industrial machine 100 is capable of communicating with the communication terminal 200B such that the communication terminal 200B can use the electronic information in a case where the communication terminal 200B is connected.

The communication terminal 200B is, for example, a portable computer capable of modular communication or data communication. The communication terminal 200B has an imaging module that acquires an image and a microphone module that acquires a sound, and an application that operates on the communication terminal 200B can perform various processes by using the acquired image and sound described above. Further, the communication terminal 200B is capable of connecting to an external camera or an external microphone. The communication terminal 200B can treat an image taken by the external camera and a sound taken by the external microphone as an alternative to the image acquired from the imaging module and the sound acquired from the microphone module described above, which are provided in the communication terminal 200B itself.

The interface unit 112 of the industrial machine 100 has the same configuration as the interface used when the external camera and the external microphone are connected to the communication terminal 200B. When the communication terminal 200B is connected to the interface unit 112, the image or the sound (electronic information) acquired or generated by the industrial machine 100 is taken into the communication terminal 200B, in the same manner as the image or the sound input from the external camera or the external microphone.

FIG. 13 illustrates an application example in which the industrial machine 100 participates in an electronic meeting, by using an application for the electronic meeting, which is provided in the communication terminal 200B. The electronic meeting is a system in which a plurality of participants can exchange information from a remote location. The electronic meeting is a service provided by an external electronic meeting providing system 50, and the plurality of participants in the electronic meeting are connected to the electronic meeting providing system 50 via a communication network. In the electronic meeting, a display frame and a sound frame are assigned to each participant, and electronic information including the image and the sound is transmitted to output the electronic information to the display frame and the sound frame of each participant. Then, the plurality of participants can communicate with each other by exchanging an image and a sound in the electronic meeting.

Through the communication terminal 200B connected to the industrial machine 100 participating in the electronic meeting, electronic information including the image and the sound acquired or generated by the industrial machine 100 can be output to an image frame and a sound frame assigned to the communication terminal 200B. A display image 51 in FIG. 13 illustrates an example in which an image output and a sound output (indicated by a balloon pattern in FIG. 13) are performed from the industrial machine 100 in a state in which a plurality of display frames 55 of the participants are output in a list format and the sounds of the plurality of participants can be output simultaneously. The display image 51 is displayed on a display unit of each participant. By using the electronic information on the industrial machine 100 as described above, a state of the industrial machine 100 and the periphery thereof can be transmitted to the participants of the electronic meeting, and can be used for various types of management of the industrial machine 100.

### HARDWARE CONFIGURATION OF INDUSTRIAL MACHINE

The cab 120 is provided with an operation unit 121 for operating the first drive unit 140, a rotating unit of the rotating platform 160, and the second drive unit 180. The cab 120 is further provided with the first microphone 122 that acquires a sound in the cab 120, the first camera 123 that acquires a captured image in the cab 120, the first speaker 124 that outputs a sound to the cab 120, and the first display unit 125 that outputs an image to the cab 120. Further, the first detector 126 that detects an object (a driver or the like) in the cab 120 is provided in the cab 120. For example, a three-dimensional scanner or the like using an infrared laser can be applied as the first detector 126.

Further, the rotating platform 160 is provided with the second camera 161a to the fourth camera 161c for acquiring a captured image of the periphery (rearward, leftward, rightward, or the like) and the second microphone 162a to the fourth microphone 162c for acquiring a peripheral sound. Further, a second detector 163a to a fourth detector 163c for detecting a person, an object, or the like located in the periphery (rearward, leftward, rightward, or the like) is provided in the rotating platform 160. For example, a three-dimensional scanner or the like using an infrared laser can be applied as the second detector 163a to the fourth detector 163c.

Further, a first switch 127 for issuing an output request from the cab 120 to the electronic meeting is provided in the cab 120 of the industrial machine 100. On the outside of the industrial machine 100 (for example, rear, left, right, or the like of the rotating platform 160), the second switch 164a to the fourth switch 164c for issuing an output request from the periphery of the industrial machine 100 to the electronic meeting and the second speaker 165 for outputting a sound to the periphery are provided.

Further, the industrial machine 100 is provided with the sensor group 101 (a stress sensor, a vibration sensor, a temperature sensor, and the like) for performing a self-diagnosis, the internal microphone group 102 for detecting an operation sound of the machine, and the internal camera group 103 for acquiring an image inside the machine. The sensor group 101, the internal microphone group 102, and the internal camera group 103 are provided in a machine room driven by a drive source and each machine unit generating a large stress.

Further, the industrial machine 100 is provided with the interface unit 112 described above, which is communicably connected to the external communication terminal 200B. For example, the interface unit 112 is provided in the cab 120 or an accommodation chamber of a control device.

### CONTROL CONFIGURATION

The industrial machine 100 includes a control controller that controls a machine operation, although not illustrated. The control controller receives an operation signal or operation power from the operation unit 121 of the cab 120, and drives the first drive unit 140, the second drive unit 180, or a rotating unit of the rotating platform 160 in response to the operation signal or the operation power. With this drive, the industrial machine 100 is driven in response to an operation of a driver. The control controller further includes an automatic operation function. When the operator selects the automatic operation, the control controller operates the industrial machine 100 while detecting a person or an obstacle in the periphery, based on an output of the second detector 163a to the fourth detector 163c. In the automatic operation function, the control controller temporarily stops the operation in a case where the person or the obstacle is detected in the periphery, and the operation cannot be continued.

As illustrated in FIG. 12, the industrial machine 100 includes the information processing unit 300 that acquires or generates electronic information including an image and a sound related to the industrial machine 100 and its periphery, and an input and output control unit 400B that exchanges information with the communication terminal 200B. The information processing unit 300 and the input and output control unit 400B are computers that execute a control program, and each module of the information processing unit 300 and the input and output control unit 400B is software that is realized by the computer executing the control program. The information processing unit 300 and the input and output control unit 400B may be configured to be realized by one computer. The computer may be referred to as a control device.

The information processing unit 300 includes an image generation unit 310 that generates electronic information on an image, a sound generation unit 320 that generates electronic information on a sound, a character string generation unit 330 that generates electronic information on a character string, an information generation unit 340 that generates detection information on a specific state related to the industrial machine 100, and a content information generation unit 350 that generates content information.

### INFORMATION GENERATION UNIT

The information generation unit 340 performs image recognition, sound recognition, and a machine state diagnosis.

The image recognition is a process of performing image recognition on an image of the first camera 123, the fourth camera 161c, and the internal camera group 103 to generate each piece of information such as the presence or absence of a person and a position thereof, the presence or absence of an obstacle and a position thereof, and the presence or absence of abnormality occurrence.

The sound recognition is a process of performing sound recognition on a sound acquired by the first microphone 122 to the fourth microphone 162c and the internal microphone group 102 to generate information indicating human speech, information on the presence or absence of an abnormality in a machine sound, and the like. The information indicating the human speech may include information on a voice command for the industrial machine 100 and information on a voice command for an electronic meeting.

The machine state diagnosis is a process of diagnosing a state of each unit of the machine based on an output of the sensor group 101, the internal microphone group 102, and the internal camera group 103 to generate self-diagnosis information indicating a result of the diagnosis. The state diagnosis is a diagnosis by a self-diagnosis function. The information generation unit 340 generates a graph indicating a transition of an output value from the output value of the sensor group 101 as a part of the self-diagnosis information. In addition, the information generation unit 340 has a database in which an output of the sensor group 101 and information on the diagnosis result are associated with each other in advance, and generates electronic information including the information on the diagnosis result by collating the self-diagnosis information with the database. The information on the diagnosis result is not limited to being generated based on the database, and may be generated by using a statistical model or a machine learning model.

The information generated by the information generation unit 340 may be transmitted to an electronic meeting system via the input and output control unit 400B. Alternatively, the information generated by the information generation unit 340 may be transmitted to the image generation unit 310, the sound generation unit 320, and the character string generation unit 330 and processed into image information, sound information, and character string information.

### IMAGE GENERATION UNIT

The image generation unit 310 performs image editing, information visualization, and sound visualization to generate electronic information on an image.

The information visualization is a process of converting information generated by the information generation unit 340 into visualization data such as an image. The process includes a process of creating image data of self-diagnosis information, a machine operation state or a control state, and a graph, a table, and a figure included in each work report of the industrial machine 100. More specifically, as a result of the process, a mark image corresponding to a person or an obstacle detected in the periphery of the industrial machine 100, image data in which a magnitude or a frequency of a machine sound acquired by the internal microphone group 102 is represented or graphed, image data in which a detection result of the sensor group 101 is represented or graphed, image data in which self-diagnosis information or a diagnosis result is represented or graphed, image data in which a work history of the industrial machine 100 is represented or converted into a movement trajectory image, and the like are created. For example, the information generation unit 340 accumulates a series of position data obtained from a positioning system (not illustrated), and the image generation unit 310 can generate a movement trajectory image from the position data and map image data.

The sound visualization is a process of converting information obtained by the image recognition and the sound recognition of the information generation unit 340 into a character string image, and a process of creating image data in which a magnitude of an operation sound of the machine acquired by the internal microphone group 102 is represented by a histogram.

The image editing is a process of generating one piece of electronic information by arranging formats of individual images of the first camera 123 to the fourth camera 161c and the internal camera group 103, or creating one piece of electronic information by synthesizing one or both of the visualization data and the sound-visualized data described above with these images. Further, the image editing may include a process of creating one piece of electronic information by synthesizing images of the second camera 161a to the fourth camera 161c. Further, the image generation unit 310 can generate a bird's-eye view image of the industrial machine 100 as one piece of electronic information by synthesizing the images of the second camera 161a to the fourth camera 161c through a process of the image editing.

The information generated by the image generation unit 310 may be transmitted to be output to a shared screen of the electronic meeting system or to a display frame assigned to each participant via the input and output control unit 400B. In addition, the information generated by the image generation unit 310 may be transmitted to the content information generation unit 350 and used as image information on content information (to be described below).

### SOUND GENERATION UNIT

The sound generation unit 320 performs sound editing and information reading to generate electronic information on a sound.

The information reading is a process of generating a synthesis sound obtained by converting information generated by the information generation unit 340 by mechanical reading.

The sound editing is a process of generating one piece of electronic information by arranging a format of a sound input from any of the first microphone 122 to the fourth microphone 162c, or generating a synthesis sound generated by information reading as one piece of electronic information. The sound editing may include a process of extracting a target sound such as a human voice and a process of reducing a noise.

The information generated by the sound generation unit 320 may be transmitted as a sound to be output to a sound frame assigned to each participant in the electronic meeting system, via the input and output control unit 400B. In addition, the information generated by the sound generation unit 320 may be transmitted to the content information generation unit 350 and used as sound information on content information (to be described below).

### CHARACTER STRING GENERATION UNIT

The character string generation unit 330 performs sound-to-character conversion and description text generation to generate electronic information on a character string.

The sound-to-character conversion is a process of generating a character string corresponding to a person's speech detected by sound recognition.

The description text generation is a process of creating a description text corresponding to self-diagnosis information or a diagnosis result, a description text corresponding to an operation state or a control state of the industrial machine 100, and a description text corresponding to a work history of the industrial machine 100. The information generation unit 340 has a database in which the self-diagnosis information or the diagnosis result is associated with information on a description text, a database in which the operation state or the control state of the industrial machine 100 is associated with the information on the description text, and a database in which the work history of the industrial machine 100 is associated with the information on the description text in advance, and generates the information on the description text described above by using the database.

The information generated by the character string generation unit 330 may be transmitted as a character string output by the character string exchange function of the electronic meeting system via the input and output control unit 400B. In addition, the information generated by the sound generation unit 320 may be transmitted to the content information generation unit 350 and used as character string information on content information (to be described below).

### CONTENT INFORMATION GENERATION UNIT

The content information generation unit 350 generates content information by receiving information on an image, a sound, and a character string from the image generation unit 310, the sound generation unit 320, and the character string generation unit 330.

The content information corresponds to electronic information obtained by generating one image by superimposing a character string to a combination of a plurality of images and further synchronizing a sound with the image, and making these pieces of information into one piece of information. The content information may be, for example, hierarchical information in which a character string element generated by the character string generation unit 330, an image element generated by the image generation unit 310, and a sound element generated by the sound generation unit 320 are aligned in the same order. The content information includes content information including self-diagnosis information, content information in which an operation state or a control state of the machine is represented, content information in which a work report of the industrial machine 100 is represented, and the like. The work report is a report in which the work history of the industrial machine 100 is summarized in a report format.

The content information generated by the content information generation unit 350 may be transmitted to be output to a shared screen and a shared sound of the electronic meeting system or to a display frame and a sound frame assigned to each participant via the input and output control unit 400B.

### INPUT AND OUTPUT CONTROL UNIT

The input and output control unit 400B performs control to transfer electronic information between the information processing unit 300 and the communication terminal 200B. The input and output control unit 400B includes an image output portion 401B that outputs electronic information on an image to the communication terminal 200B, a sound output portion 402B that outputs electronic information on a sound to the communication terminal 200B, a sound input portion 403B that inputs sound data (external sound) from the communication terminal 200B, and a switching unit 404B that switches electronic information to be output to the communication terminal 200B. The sound data input from the sound input portion 403B is transmitted to the first speaker 124 or the second speaker 165 and output as a sound. In addition, the input and output control unit 400B may include an image input portion that inputs image data (external image) from the communication terminal 200B, and the image may be output from the first display unit 125 or the like.

The image output portion 401B and the sound output portion 402B output electronic information on the image and electronic information on the sound to the communication terminal 200B. In a case where an external camera and an external microphone are connected to the communication terminal 200B, the image output portion 401B and the sound output portion 402B output electronic information to the communication terminal 200B in the same format as a format in which the image data and the sound data are transmitted from the external camera and the external microphone.

The switching unit 404B selects electronic information to be transmitted to the communication terminal 200B, from a plurality of pieces of electronic information acquired or generated by the information processing unit 300, based on various conditions to be described below, and switches the input of the image output portion 401B and the input of the sound output portion 402B such that the electronic information is transmitted to the communication terminal 200B.

The switching unit 404B determines a priority level of each electronic information from a content of each piece of electronic information to select the electronic information to be transmitted to the communication terminal 200B from the plurality of pieces of electronic information. For example, the switching unit 404B identifies a person or an obstacle in the image via an image recognition process when the electronic information is a surrounding image, and determines that the closer the person or the obstacle is, the higher the priority level is. In addition, in a case where the electronic information on the image includes a character string image of a description text and includes a character string having a predetermined high importance, the priority level is determined to be high in accordance with the importance. In addition, in a case where the electronic information is a sound, the switching unit 404B may determine the priority level depending on a volume of the sound, or may determine a priority level of a peripheral sound of an image determined to have a high priority level to be high.

The switching unit 404B is further configured to take information from various functions of the industrial machine 100 to determine a condition for switching the electronic information. That is, information on the operation state (forward, backward, arm driving, and the like) of the industrial machine 100 is transmitted from the control controller of the industrial machine 100, information on an automatic operation event (start of automatic operation, stop of automatic operation due to an obstacle, and the like) is transmitted from the automatic operation function of the industrial machine 100, diagnosis information is transmitted from the self-diagnosis function of the industrial machine 100, and further, information on the periphery monitoring of the industrial machine 100 is transmitted, to the switching unit 404B.

Further, the switching unit 404B performs sound recognition on the sound data to switch the electronic information to be transmitted to the communication terminal 200B, based on the sound data (external sound) transmitted from the communication terminal 200B. Then, the switching unit 404B performs a process of extracting a command for switching the electronic information or a sound that is a trigger for switching the electronic information from the sound data. In a case where the input and output control unit 400B has a configuration in which the image data (external image) is input from the communication terminal 200B, the switching unit 404B may be configured to perform a process of extracting a command for switching the electronic information or an image that is a trigger for switching the electronic information from the image data, in the same manner.

The input and output control unit 400B can output the image and the sound of the electronic meeting transmitted from the communication terminal 200B to the first display unit 125, the first speaker 124, or the second speaker 165 via the information processing unit 300 or directly.

SPECIFIC EXAMPLE OF ELECTRONIC INFORMATION

Subsequently, a specific example of electronic information to be transmitted to an electronic meeting by the industrial machine 100 will be described. FIGS. 4A to 4C, FIGS. 5A and 5B, and FIG. 7 described above also correspond to an example of electronic information in another embodiment.

FIGS. 4A to 4C illustrate examples of electronic information including an image acquired or generated by the information processing unit 300, FIG. 4A illustrates an image example of a back monitor, FIG. 4B illustrates an image example inside a cab, and FIG. 4C illustrates an image example of the industrial machine 100 in a bird's-eye view. As illustrated in FIG. 4A, the electronic information on the image acquired or generated by the image generation unit 310 of the information processing unit 300 includes the image 31 of the back monitor acquired from a third camera 161b. The image 31 may include the image elements 311 and 312 in which a person or an obstacle detected by the third detector 163b is illustrated. In addition, as illustrated in FIG. 4B, one piece of the electronic information on the image described above includes the image 32 in the cab 120. The image in the cab 120 may be an image captured from above or in front of the cab 120. Further, as illustrated in FIG. 4C, one piece of the electronic information on the image described above includes a bird's-eye view image 33 illustrating the industrial machine 100 and the periphery thereof, which is generated by synthesizing images of the second camera 161a to the fourth camera 161c. The bird's-eye view image 33 may include the image elements 331 and 332 in which a person or an obstacle detected by the second detector 163a to the fourth detector 163c is illustrated.

FIGS. 5A and 5B illustrate an example of electronic information including content information generated by the content information generation unit 350 of the information processing unit 300, FIG. 5A is an image example of a state diagnosis report, and FIG. 5B is an example of a report image of a peripheral state or a peripheral setting state of the industrial machine 100. The report 34 of a state diagnosis in FIG. 5A includes the statistical graphs 341 and 342 of outputs of the sensor group 101 or the internal microphone group 102. The report 34 of the state diagnosis may include a character string image representing a diagnosis type or a diagnosis result. A peripheral situation of the industrial machine 100 (the number of persons or obstacles in the vicinity, the number of persons or obstacles located slightly away), a range in which the industrial machine 100 detects a person or an obstacle (left, right, left rear, right rear, and the like), or the like is illustrated in the report 35 in FIG. 5B.

FIG. 7 is a diagram illustrating an example of electronic information on a sound acquired or generated by the sound generation unit 320 of the information processing unit 300. The sound generation unit 320 can acquire sound data input from the internal microphone group 102, the first microphone 122, and each of the second microphone 162a to the fourth microphone 162c, as the sound electronic information 37a to 37c. Further, the sound generation unit 320 can generate sound data obtained by mechanically reading a character string, such as a description text generated by the character string generation unit 330, as the synthesis sound electronic information 37d.

In addition, a character string read by the sound generation unit 320 includes a description text (during an operation, during rest, during forward movement, during rearward movement, during rotating, during arm derricking, and the like) of a control state of the industrial machine 100, a description text (degree of normality of each unit based on an output of the sensor group 101, the internal microphone group 102, and the internal camera group 103) of a machine state (a self-diagnosis) of the industrial machine 100, a description text (a detection result of a person or an obstacle in the periphery, a road surface condition in the periphery, and the like) of a peripheral situation (a result of periphery monitoring), and a description text (presence or absence of a passenger, estimated activity level of the passenger obtained by the information generation unit 340 recognizing an image of the first camera 123, whether or not a driving operation is performed in accordance with a regulation, and the like) of a state of a passenger such as a driver.

The information processing unit 300 may be configured to have a plurality of types of software mixed and to generate a plurality of types of electronic information on images, sounds, or character strings by the plurality of types of software. The plurality of types of software may be software developed by different manufacturers, or may be software having different development platforms. The input and output control unit 400B can uniformly handle the electronic information generated from such a plurality of types of software, and select any one of the electronic information to transmit to an electronic meeting. That is, the input and output control unit 400B plays a role of supervising the different types of software for generating the electronic information.

### SWITCHING PROCESS OF ELECTRONIC INFORMATION

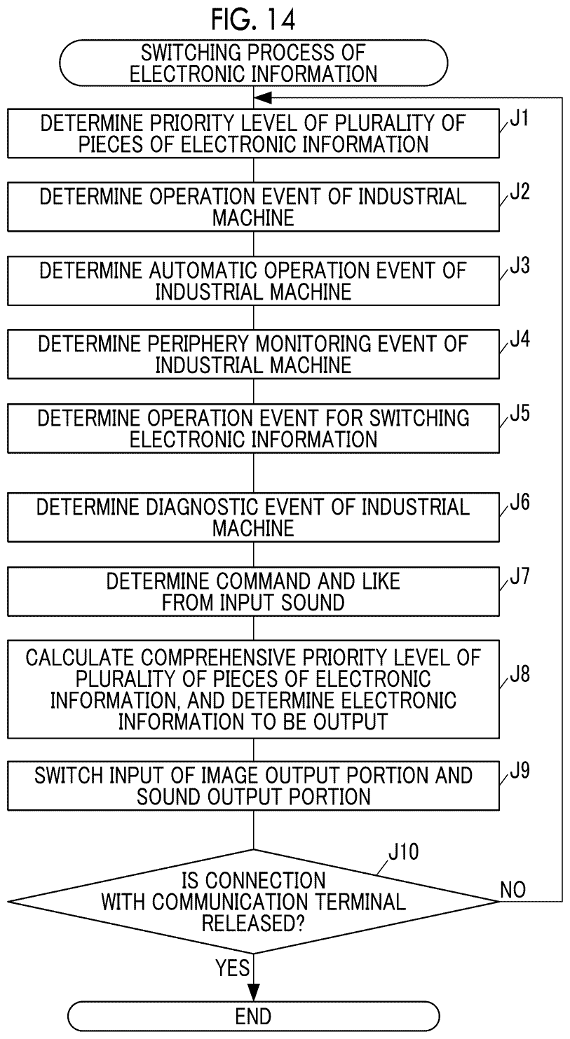

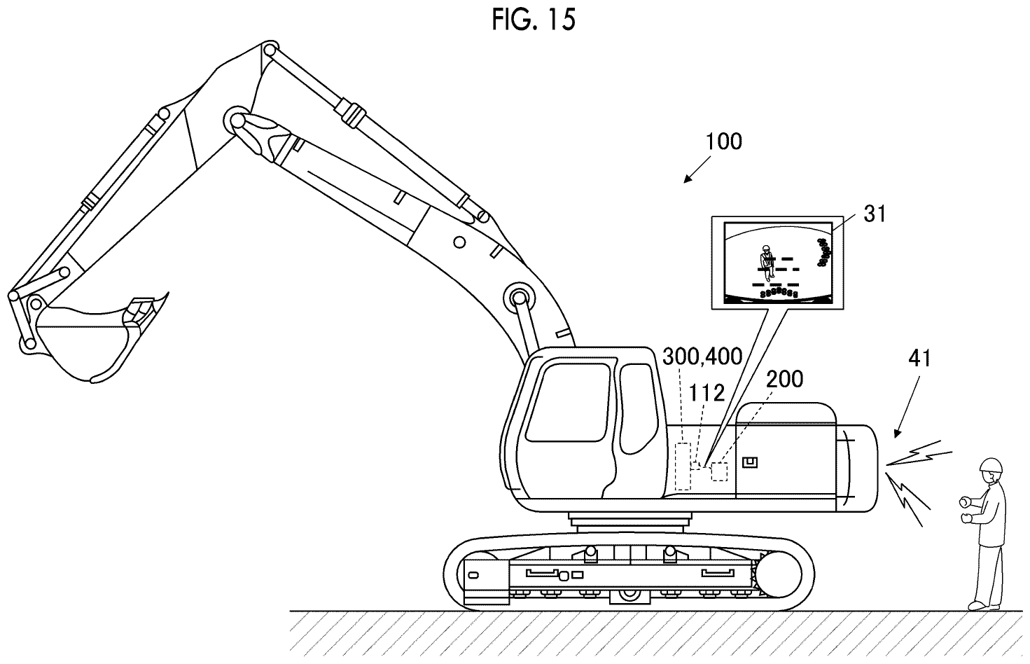

FIG. 14 is a flowchart illustrating a switching process of electronic information executed by an input and output control unit. When the communication terminal 200B is connected to the input and output control unit 400B, the switching process in FIG. 14 is started. When the switching process is started, the switching unit 404B of the input and output control unit 400B proceeds to a loop process (steps J1 to J9) of switching electronic information on an image and a sound to be output to an electronic meeting according to a condition.

When the process proceeds to the loop process, first, the switching unit 404B determines a priority level of the electronic information to be transmitted to the communication terminal 200B from contents of a plurality of pieces of electronic information received from the information processing unit 300 (step J1). The switching unit 404B holds a database in which the content of the electronic information and the priority level are associated with each other, and determines a priority level by collating the content of the electronic information recognized by an image recognition process and a sound recognition process with the database. The database described above may be a predetermined database or may be configured to be updated by machine learning. Specific examples of the priority level according to the content of the electronic information are as described above.

Subsequently, the switching unit 404B determines whether or not an occurrence notification of an operation event of the industrial machine 100 is received (step J2). The operation event includes a start of a predetermined operation (forward, rearward, rotating, arm driving, or the like) of the industrial machine 100. Further, the switching unit 404B determines whether or not an occurrence notification of an automatic operation event is received in a case where the automatic operation of the industrial machine 100 is selected (step J3). The automatic operation event includes that the automatic operation is started, that the automatic operation is stopped depending on a result of periphery monitoring, and the like.

Further, the switching unit 404B determines whether or not an occurrence notification of a periphery monitoring event of the industrial machine 100 is received (step J4). The periphery monitoring event includes detection of a person or an obstacle in front, rear, left, and right of the industrial machine 100.

Further, the switching unit 404B determines whether or not an occurrence notification of an operation event for switching the electronic information by a worker is received (step J5). The operation event includes that any one of the first switch 127 and the second switch 164a to the fourth switch 164c is operated.

Further, the switching unit 404B determines whether or not an occurrence notification of a diagnosis event of the industrial machine 100 is received (step J6). The diagnosis event includes a determination of an abnormality or a warning in a self-diagnosis function of the industrial machine 100.

Further, the switching unit 404B determines whether or not sound data input from the communication terminal 200B includes a command or a sound as a trigger for switching the electronic information (step J7).

Then, the switching unit 404B calculates a comprehensive priority level by combining a priority level determined in step J1 and a priority level corresponding to a determination result in steps J2 to J7, and determines electronic information having the highest priority level in the electronic information on the image and electronic information having the highest priority level in the electronic information on the sound, as electronic information to be transmitted to the communication terminal 200B (step J8). Then, the input of the image output portion 401B and the sound output portion 402B is switched such that the determined electronic information is transmitted to the communication terminal 200B (step J9).

Then, the switching unit 404B determines whether or not the connection with the communication terminal 200B is released (step J10), and when NO, the process returns to step J1. On the other hand, when YES, the switching process of the electronic information is ended.

### EXAMPLE OF SWITCHING ELECTRONIC INFORMATION

Subsequently, a specific example of a switching process of electronic information will be described. FIG. 15 is a diagram illustrating an example in which electronic information which is to be output is switched based on a peripheral situation. For example, in a case where a person or an obstacle approaches a rear portion of the industrial machine 100 and the person or the obstacle moves in a large range in an image of a back monitor, the switching unit 404B recognizes the content of the image and switches the output to electronic information on the image 31 of the back monitor in FIG. 4A by increasing a priority level of electronic information including the image.

Alternatively, in a case where a person or an obstacle approaches the rear portion of the industrial machine 100, the third detector 163b detects the person or the obstacle, and the warning sound 41 is output, the switching unit 404B determines that the periphery monitoring event occurs. Then, based on the occurrence of the periphery monitoring event, the switching unit 404B switches the output to the electronic information by increasing a priority level of the electronic information on the image 31 of the back monitor in FIG. 4A.

In addition, in a case where an operation event occurs in which any of the first switch 127 and the second switch 164a to the fourth switch 164c is operated by a worker, the switching unit 404B switches the output to the electronic information by increasing a priority level of the electronic information including an image and a sound of a camera and a microphone installed in the periphery of the switch.

In addition, in a case where a diagnosis event of determining an abnormality occurs in a self-diagnosis function of the industrial machine 100, the switching unit 404B increases a priority level of electronic information including an image of an abnormality diagnosis location and an image of a diagnosis report of a state diagnosis at the diagnosis location and switches the output to the electronic information.

In addition, when a predetermined command such as “switch to display of a side monitor” is spoken from an external operator connected to make a call via the communication terminal 200B, the switching unit 404B switches the output to electronic information including an image of the side monitor by increasing a priority level of the electronic information.

As described above, according to the industrial machine 100 of another embodiment, when electronic information including an image and electronic information including a sound are acquired or generated and the communication terminal 200B is connected, the industrial machine 100 communicates with the communication terminal 200B such that the communication terminal 200B can use the electronic information. Therefore, in a case where various types of application software are introduced into the communication terminal 200B, the application software can process the electronic information acquired or generated by the industrial machine 100. For example, the electronic information can be recorded, analyzed, subjected to image recognition, or subjected to sound recognition, or the electronic information can be transmitted to a remote location, or the electronic information can be taken into various information processing services. By such a process, it is possible to simplify the various types of management of the industrial machine 100.

Further, according to the industrial machine 100 of another embodiment, the information processing unit 300 acquires or generates a plurality of pieces of electronic information, and the switching unit 404B switches the electronic information to be output to the communication terminal 200B from the plurality of pieces of electronic information according to a condition. With this configuration, even when a large number of pieces of electronic information which can be output exist, the electronic information corresponding to the situation can be transmitted to the communication terminal 200B.

Specifically, the electronic information on the image acquired or generated by the information processing unit 300 includes two or more of a captured image inside or in the periphery of the industrial machine 100, a bird's-eye view image of the industrial machine 100 in which a plurality of captured images in the periphery are synthesized, a captured image of the cab, content information including self-diagnosis information, content information in which an operation state or a control state of the machine is represented, content information in which a work report of the industrial machine 100 is represented, a character string image obtained by converting a speech sound input into a character string image, an image of a character string related to a self-diagnosis, and an image of a character string related to a periphery monitoring result. The information processing unit 300 may be configured to superimpose machine identification information capable of identifying that the electronic information is output from the industrial machine 100 and type identification information capable of identifying a type of a content included in the electronic information, on these images. As the machine identification information, for example, a symbol or a name capable of identifying the individual industrial machine 100 can be adopted. As the type identification information, in a case of a camera image, a symbol or a name of an imaging location capable of identifying which camera the image comes from may be adopted.

Further, the electronic information on the sound acquired or generated by the information processing unit 300 includes two or more of the peripheral sound of the industrial machine 100, the sound of the cab 120, the operation sound of the machine, and the synthesis sound obtained by converting the character string into a sound. The character string described above corresponds to a description text generated by the character string generation unit 330 or a text character string after sound-to-character conversion. With this configuration, the state of the industrial machine 100 and the periphery thereof can be more accurately represented by the plurality of pieces of electronic information.

In addition, in another embodiment, the industrial machine 100 is described as having the configuration for acquiring or generating all the electronic information described above, but may have a configuration for acquiring or generating only the electronic information on the image or only the electronic information on the sound. In addition, two or more of the plurality of types of electronic information described above may be acquired or generated. Since there are more types of electronic information, it is possible to more efficiently perform various types of management by effectively utilizing the electronic information. However, even with a small number of types of electronic information, the electronic information can be used for various types of management of the industrial machine 100.

Further, the condition under which the switching unit 404B switches the electronic information includes a condition based on the contents of the plurality of pieces of electronic information. For example, the electronic information on the image or the sound includes content that can be determined to have a high or low importance, such as the presence or absence and a size of an obstacle, a normality or an abnormality of a diagnosis result, a character string indicating any report, and a volume of the sound. Therefore, the electronic information is switched in accordance with such content, so that the electronic information suitable for various types of management of the industrial machine 100 can be output. The condition under which the switching unit 404B switches the electronic information may be configured to be changeable in setting from the communication terminal 200B.

Further, the switching unit 404B switches the electronic information to be used by the communication terminal 200B based on the event of the industrial machine 100. Specifically, the event described above includes a self-diagnosis event of the industrial machine 100, an operation event of the industrial machine 100, an automatic operation event of the industrial machine 100, a periphery monitoring event of the industrial machine 100, and an operation event for switching electronic information. With this configuration, it is possible to output electronic information suitable for various types of management of the industrial machine 100.

Further, the input and output control unit 400B inputs an external sound from the communication terminal 200B, and the switching unit 404B switches the electronic information to be output, based on the external sound. With this configuration, when a command or the like is spoken from a manager or an operator connected to make a call via the communication terminal 200B, the electronic information to be transmitted to the communication terminal 200B can be switched by the vocalization. With this configuration, the manager or the operator can request the switching of the electronic information from a remote location. Therefore, the manager or the operator can efficiently acquire the electronic information suitable for various types of management of the industrial machine 100. The external sound may be replaced with an external image, or both the external sound and the external image may be used.

Further, in a case where one or both of the external camera and the external microphone are connected to the connectable communication terminal 200B, the input and output control unit 400B transmits the electronic information to the communication terminal 200B as an input from the external camera and the external microphone. With such a configuration, the electronic information on the image and the sound of the industrial machine 100 can be taken into various applications (applications using captured images and recorded sound) introduced into the communication terminal 200B, and can be processed like the captured image and the recorded sound of the communication terminal 200B. Therefore, a process or a service by various existing applications can be applied to the electronic information from the industrial machine 100.

Another embodiment of the present invention has been described above. However, the present invention is not limited to another embodiment. For example, in another embodiment, the example in which the industrial machine 100 is a power excavator is described. However, the industrial machine 100 may be a machine used in various industries, such as a work machine such as a construction machine and a transport machine, a machine tool, an agricultural machine, a forming device, an industrial robot, and plant equipment. In addition, details illustrated in another embodiment can be appropriately changed without departing from the gist of the invention.

The disclosures of the specification, drawings, and abstracts included in each of Japanese Patent Application No. 2023-022074 filed on Feb. 16, 2023 and Japanese Patent Application No. 2023-022075 filed on Feb. 16, 2023 are incorporated herein by reference in their entirety.

### INDUSTRIAL APPLICABILITY

The present invention can be used for an industrial machine.

It should be understood that the invention is not limited to the above-described embodiment, but may be modified into various forms on the basis of the spirit of the invention. Additionally, the modifications are included in the scope of the invention.

What is claimed is:

1. An industrial machine that executes an information process for participating in an electronic meeting.

2. The industrial machine according to claim 1,
wherein the information process includes at least one of a process of accepting an invitation for the electronic meeting and a process of holding the electronic meeting.

3. The industrial machine according to claim 1,
wherein the information process includes a process of transmitting identification information on the industrial machine as information for identifying a participant in the electronic meeting.

4. The industrial machine according to claim 1,
wherein the information process includes a process of acquiring or generating a plurality of pieces of electronic information to be output to the electronic meeting, and
the electronic information includes at least one of an image, a sound, and a character string.

5. The industrial machine according to claim 4,
wherein the plurality of pieces of electronic information include two or more of a captured image inside or in a periphery of the industrial machine, a bird's-eye view image of the industrial machine in which a plurality of captured images in the periphery are synthesized, a captured image of a cab, content information including self-diagnosis information, content information in which an operation state or a control state of the industrial machine is represented, content information in which a work report of the industrial machine is represented, a peripheral sound, a sound of the cab, an operation sound of the industrial machine, a character string obtained by converting speech of a driver, a character string obtained by converting speech of a worker in the periphery, a character string related to a self-diagnosis, a character string related to a monitoring result in the periphery, and a synthesis sound obtained by converting the character string into a sound.

6. The industrial machine according to claim 4,
wherein the information process includes a process of switching the electronic information to be output to the electronic meeting from among the plurality of pieces of electronic information according to a condition.

7. The industrial machine according to claim 6,
wherein the condition includes at least one of a request of another participant in the electronic meeting, a self-diagnosis event of the industrial machine, an operation event of the industrial machine, an automatic operation event of the industrial machine, a periphery monitoring event of the industrial machine, and an operation event for the electronic meeting of the industrial machine.

8. The industrial machine according to claim 1, further comprising:
a speaker that outputs a sound,
wherein the information process includes a process of outputting a sound transmitted via the electronic meeting or a synthesis sound obtained by converting output information transmitted via the electronic meeting into a sound, from the speaker.

9. The industrial machine according to claim 2,
wherein the invitation for the electronic meeting is made, based on a self-diagnosis event of the industrial machine, an automatic operation event of the industrial machine, or a periphery monitoring event of the industrial machine.

10. The industrial machine according to claim 1,
wherein electronic information including one or both of an image and a sound is acquired or generated, and in a case where a communication terminal is connected, the industrial machine communicates with the communication terminal such that the communication terminal uses the electronic information.

11. The industrial machine according to claim 10,
wherein a plurality of pieces of the electronic information are acquired or generated, and the electronic information to be used by the communication terminal is switched from among the plurality of pieces of electronic information according to a condition.

12. The industrial machine according to claim 11,
wherein the plurality of pieces of electronic information include two or more of a captured image inside or in a periphery of the industrial machine, a bird's-eye view image of the industrial machine in which a plurality of captured images in the periphery are synthesized, a captured image of a cab, content information including self-diagnosis information, content information in which an operation state or a control state of the industrial machine is represented, content information in which a work report of the industrial machine is represented, a character string image obtained by converting an input speech sound into a character string image, an image of a character string related to a self-diagnosis, and an image of a character string related to a monitoring result in the periphery.

13. The industrial machine according to claim 11,
wherein the plurality of pieces of electronic information include two or more of a peripheral sound, a sound of a cab, an operation sound of the industrial machine, and a synthesis sound obtained by converting a character string into a sound.

14. The industrial machine according to claim 11,
wherein the electronic information to be used by the communication terminal is switched based on a content of the plurality of pieces of electronic information.

15. The industrial machine according to claim 11,
wherein the electronic information to be used by the communication terminal is switched based on an event of the industrial machine.

16. The industrial machine according to claim 15,
wherein the event includes at least one of a self-diagnosis event of the industrial machine, an operation event of the industrial machine, an automatic operation event of the industrial machine, a periphery monitoring event of the industrial machine, and an operation event for switching the electronic information.

17. The industrial machine according to claim 11,
wherein one or both of an external image and an external sound are input from the communication terminal, and the electronic information to be used by the communication terminal is switched based on one or both of the external image and the external sound.

18. The industrial machine according to claim 10,
wherein the image of the electronic information is superimposed with machine identification information for identifying that the electronic information is output from the industrial machine, type identification information for identifying a type of a content included in the electronic information, or both of the machine identification information and the type identification information.

19. The industrial machine according to claim 10,
wherein in a case where one or both of an external camera and an external microphone are connected to the communication terminal which is connectable, the electronic information is transmitted to the communication terminal as an input from one or both of the external camera and the external microphone.
